(19) United States
(12) Patent Application Publication
(10) Pub. No.: US 2016/0172657 A1
(43) Pub. Date: Jun. 16, 2016

(54) SECONDARY BATTERY, BATTERY PACK, ELECTRIC VEHICLE, ELECTRIC POWER STORAGE SYSTEM, ELECTRIC POWER TOOL, AND ELECTRONIC APPARATUS

(71) Applicant: SONY CORPORATION, Tokyo (JP)

(72) Inventors: TAKAAKI MATSUI, Fukushima (JP); OSAMU HARADA, Fukushima (JP); MASAKI KURATSUKA, Fukushima (JP)

(21) Appl. No.: 14/908,194

(22) PCT Filed: Oct. 21, 2014
(86) PCT No.: PCT/JP2014/005325

§ 371 Date: Jan. 28, 2016

(30) Foreign Application Priority Data
Oct. 31, 2013 (JP) 2013-226504
Oct. 8, 2014 (JP) 2014-207281

(51) Int. Cl. H01M 2/34; H01M 10/42; H01M 4/62; H01M 10/052

(52) U.S. Cl. CPC H01M 2/345; H01M 10/052; H01M 10/4235; H01M 4/62; H01M 2200/20

(57) ABSTRACT

A secondary battery is provided. The secondary battery includes an outer package (11); an electrode structure (20) contained inside the outer package, wherein the electrode structure includes an anode (22) and a cathode (21); an electrolytic solution contained inside the outer package, and a safety valve mechanism (15) configured to interrupt a current in accordance with an internal pressure of the outer package, wherein at least one of the non-impregnation electrolytic solution is in an amount so as to increase an operation probability of the safety valve mechanism and the anode includes a material that electrochemically generates gas at an anode potential so as to increase an operation probability of the safety valve mechanism.

### CROSS REFERENCE TO RELATED APPLICATIONS

This application claims the benefit of Japanese Priority Patent Application JP 2013-226504 filed Oct. 31, 2013, the entire contents of each which are incorporated herein by reference.

### TECHNICAL FIELD

The present technology relates to a secondary battery that includes a safety mechanism. The present technology also relates to a battery pack, an electric vehicle, an electric power storage system, an electric power tool, and an electronic apparatus that use the secondary battery.

### BACKGROUND ART

In recent years, various electronic apparatuses such as a mobile phone and a personal digital assistant (PDA) have been widely used, and it has been demanded to further reduce the size and the weight of the electronic apparatuses and to achieve their long life. Accordingly, as an electric power source for the electronic apparatuses, a battery, in particular, a small and light-weight secondary battery capable of achieving high energy density has been developed.

In these days, it has been considered to apply such a secondary battery to various other applications in addition to the foregoing electronic apparatuses. Examples of such other applications may include a battery pack attachably and detachably mounted on the electronic apparatuses or the like, an electric vehicle such as an electric automobile, an electric power storage system such as a home electric power server, and an electric power tool such as an electric drill.

Secondary batteries utilizing various charge-discharge principles to obtain a battery capacity have been proposed. In particular, a secondary battery utilizing insertion and extraction of an electrode reactant has attracted attention, since such a secondary battery achieves high energy density.

The secondary battery includes a cathode, an anode, and an electrolytic solution. The cathode includes a cathode active material layer. The cathode active material layer contains a cathode active material that inserts and extracts the electrode reactant. The anode includes an anode active material layer. The anode active material layer contains an anode active material that inserts and extracts the electrode reactant.

Concerning the secondary battery, it may be important to improve battery characteristics such as a battery capacity; however, it may be also important to secure safety in use thereof. Therefore, various considerations have been given to a configuration of the secondary battery.

Specifically, in order to stably charge a battery while preventing expansion of the electrode body, a liquid retention amount of a separator and an amount of an organic electrolytic solution per internal volume of a unit battery are defined (for example, see PTL 1 and PTL 2). In order to secure safety when an abnormal incidence occurs without degrading the battery characteristics, a ratio of a volume of a free electrolytic solution to a volume of a space inside the battery is defined (for example, see PTL 3). In order to suppress expansion of the battery when the battery is stored under high temperature, a ratio (MO/MA) of an amount MO of an electrolytic solution that exists between the electrode body and the outer package to an amount MA of the electrolytic solution that exists inside the outer package is defined (for example, see PTL 4).

Other than the above-described techniques, a gas generating plate that contains a substance (such as lithium carbonate) that generates gas when the battery is over-charged is used (for example, see PTL 5). In order to release, at an early timing, the gas generated inside the battery when the battery is over-charged, a member (such as lithium carbonate) that is electrically and chemically decomposed under a condition of an increase in a cathode potential is used (for example, see PTL 6). In order to prevent electrodeposition of metallic lithium caused by over-charging and over-discharging, 2-methyl-1,3-butadiene, bromobenzene, etc. are contained in a non-aqueous electrolytic solution (for example, see PTL 7). In order to prevent over-charging and over-discharging, a voltage detection means is provided in each battery that configures a battery module (for example, see PTL 8). In order to improve charge-discharge cycle characteristics, an amount of the non-aqueous electrolytic solution with respect to a discharge capacity of the battery is defined (for example, see PTL 9).

### CITATION LIST

### Patent Literature

PTL 1: JP 2005-100930A
PTL 2: JP 2005-100929A
PTL 3: JP 2001-185223A
PTL 4: JP 2008-071731A
PTL 5: JP 2010-199035A
PTL 6: JP 2006-260990A
PTL 7: JP H11-097059A
PTL 8: JP 2002-223525A
PTL 9: JP 2001-229980A

### SUMMARY

### Technical Problem

Various configurations have been proposed for a secondary battery. However, there may still be a room for achieving both improvement in battery characteristics and improvement in securing safety. In particular, in a secondary battery that includes a safety mechanism that interrupts a current in accordance with an internal pressure of an outer package, a relationship of so-called trade-off is established between the battery characteristics and the safety, which may still have a room for improvement.

It is desirable to provide a secondary battery, a battery pack, an electric vehicle, an electric power storage system, an electric power tool, and an electronic apparatus that are capable of achieving both improvement in battery characteristics and improvement in securing safety.

### Solution to Problem

According to an embodiment of the present technology, there is provided a secondary battery including an outer package; an electrode structure contained inside the outer package, wherein the electrode structure includes an anode and a cathode; an electrolytic solution contained inside the outer package, and a safety valve mechanism configured to interrupt a current in accordance with an internal pressure of the outer package, wherein at least one of the non-impregnation electrolytic solution is in an amount so as to increase an operation probability of the safety valve mechanism and the anode includes a material that electrochemically generates gas at an anode potential so as to increase an operation probability of the safety valve mechanism. According to an embodiment of the present technology, there is provided a secondary battery including: an outer package; an electrode structure contained inside the outer package; an electrolytic solution contained inside the outer package; and a safety mechanism configured to interrupt a current in accordance with an internal pressure of the outer package. The electrolytic solution includes an impregnation electrolytic solution with which the electrode structure is impregnated and a non-impregnation electrolytic solution with which the electrode structure is not impregnated. A ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

According to another embodiment of the present technology, there is provided a secondary battery including: an outer package; an electrode structure contained inside the outer package; an electrolytic solution contained inside the outer package; and a safety mechanism configured to interrupt a current in accordance with an internal pressure of the outer package. The electrolytic solution includes an impregnation electrolytic solution with which the electrode structure is impregnated and a non-impregnation electrolytic solution with which the electrode structure is not impregnated. A volume of the non-impregnation electrolytic solution is a volume that allows the internal pressure of the outer package to increase up to a pressure that allows the safety mechanism to operate in an over-load state.

According to an embodiment of the present technology, there is provided a battery pack including: a secondary battery; a control section configured to control operation of the secondary battery; and a switch section configured to switch the operation of the secondary battery according to an instruction of the control section. The secondary battery includes: an outer package; an electrode structure contained inside the outer package; an electrolytic solution contained inside the outer package; and a safety mechanism configured to interrupt a current in accordance with an internal pressure of the outer package. The electrolytic solution includes an impregnation electrolytic solution with which the electrode structure is impregnated and a non-impregnation electrolytic solution with which the electrode structure is not impregnated. A ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

According to an embodiment of the present technology, there is provided an electric vehicle including: a secondary battery; a conversion section configured to convert electric power supplied from the secondary battery into drive power; a drive section configured to operate according to the drive power; and a control section configured to control operation of the secondary battery. The secondary battery includes: an outer package; an electrode structure contained inside the outer package; an electrolytic solution contained inside the outer package; and a safety mechanism configured to interrupt a current in accordance with an internal pressure of the outer package. The electrolytic solution includes an impregnation electrolytic solution with which the electrode structure is impregnated and a non-impregnation electrolytic solution with which the electrode structure is not impregnated. A ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

According to an embodiment of the present technology, there is provided an electric power storage system including: a secondary battery; one or more electric devices configured to be supplied with electric power from the secondary battery; and a control section configured to control the supplying of the electric power from the secondary battery to the one or more electric devices. The secondary battery includes: an outer package; an electrode structure contained inside the outer package; an electrolytic solution contained inside the outer package; and a safety mechanism configured to interrupt a current in accordance with an internal pressure of the outer package. The electrolytic solution includes an impregnation electrolytic solution with which the electrode structure is impregnated and a non-impregnation electrolytic solution with which the electrode structure is not impregnated. A ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

According to an embodiment of the present technology, there is provided an electric power tool including: a secondary battery; and a movable section configured to be supplied with electric power from the secondary battery. The secondary battery includes: an outer package; an electrode structure contained inside the outer package; an electrolytic solution contained inside the outer package; and a safety mechanism configured to interrupt a current in accordance with an internal pressure of the outer package. The electrolytic solution includes an impregnation electrolytic solution with which the electrode structure is impregnated and a non-impregnation electrolytic solution with which the electrode structure is not impregnated. A ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

According to an embodiment of the present technology, there is provided an electronic apparatus including a secondary battery as an electric power supply source. The secondary battery includes: an outer package; an electrode structure contained inside the outer package; an electrolytic solution contained inside the outer package; and a safety mechanism configured to interrupt a current in accordance with an internal pressure of the outer package. The electrolytic solution includes an impregnation electrolytic solution with which the electrode structure is impregnated and a non-impregnation electrolytic solution with which the electrode structure is not impregnated. A ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

### Advantageous Effects of Invention

According to the secondary battery according to the above-described embodiments of the present technology, the ratio of the volume of the non-impregnation electrolytic solution to the internal volume of the outer package is from 0.31% to 7.49% both inclusive when the battery voltage is 4.2 V. Therefore, it is possible to achieve both improvement in battery characteristics and improvement in securing safety. According to the battery pack, the electric vehicle, the electric power storage system, the electric power tool, and the electronic apparatus, similar effects are achieved.

It is to be noted that effects of the present technology are not limited to the effects described above, and may be any effect disclosed in the present technology.

It is to be understood that both the foregoing general description and the following detailed description are exemplary, and are intended to provide further explanation of the technology as claimed.

### BRIEF DESCRIPTION OF DRAWINGS

FIG. 1 is a cross-sectional view illustrating a configuration of a secondary battery (of a cylindrical type) according to an embodiment of the present technology.

FIG. 2 is a cross-sectional view illustrating an enlarged part of a spirally wound electrode body illustrated in FIG. 1.

FIG. 3 is a cross-sectional view for explaining an internal volume of a battery can.

FIG. 4 is a block diagram illustrating a configuration of an application example (a battery pack) of the secondary battery.

FIG. 5 is a block diagram illustrating a configuration of an application example (an electric vehicle) of the secondary battery.

FIG. 6 is a block diagram illustrating a configuration of an application example (an electric power storage system) of the secondary battery.

FIG. 7 is a block diagram illustrating a configuration of an application example (an electric power tool) of the secondary battery.

FIG. 8 is a perspective view illustrating a configuration of the battery pack illustrated in FIG. 4.

### DESCRIPTION OF EMBODIMENTS

An embodiment of the present technology is described below in detail with reference to the drawings. The description is given in the following order.
1. Secondary Battery
1-1. Configuration
1-1-1. Cathode
1-1-2. Anode
1-1-3. Separator
1-1-4. Electrolytic Solution
1-2. Means for Safety
1-2-1. Non-impregnation Solution Ratio
1-2-2. Melting Point of Separator
1-2-3. Gas Generating Substance
1-3. Operation
1-4. Manufacturing Method
1-5. Functions and Effects
2. Applications of Secondary Battery
2-1. Battery Pack
2-2. Electric Vehicle
2-3. Electric Power Storage System
2-4. Electric Power Tool

1. Secondary Battery

1-1. Configuration

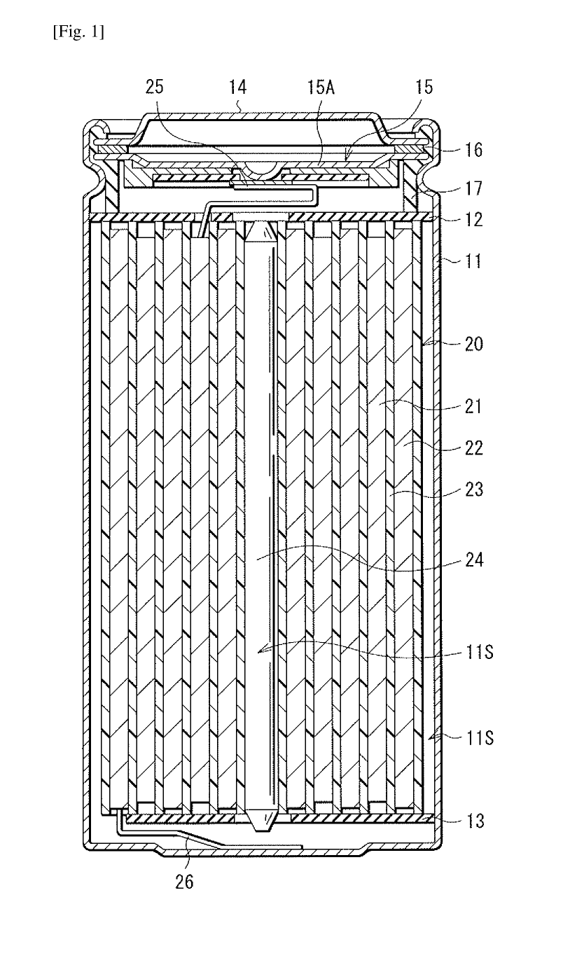

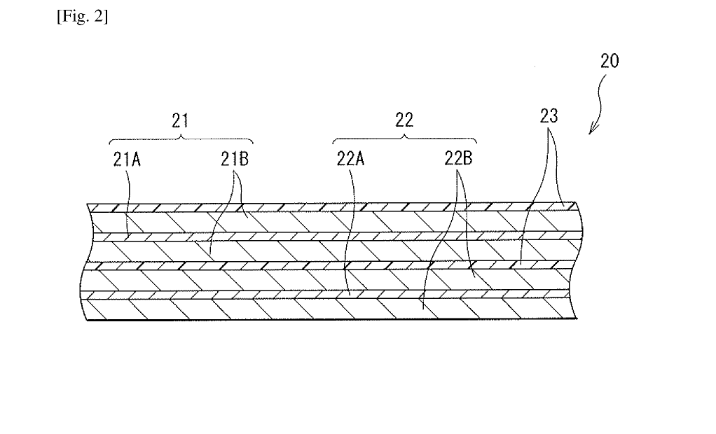

FIGS. 1 and 2 each illustrate a cross-sectional configuration of a secondary battery according to an embodiment of the present technology. FIG. 2 illustrates enlarged part of a spirally wound electrode body 20 illustrated in FIG. 1.

The secondary battery described in this example is a lithium secondary battery (a lithium ion secondary battery) in which a capacity of an anode 22 is obtained by insertion and extraction of lithium (Li) that is an electrode reactant.

For example, the secondary battery may contain the spirally wound electrode body 20 and a pair of insulating plates 12 and 13 inside a battery can 11. A type of the secondary battery using the battery can 11 is called a cylindrical type.

The battery can 11 is an outer package that contains the spirally wound electrode body 20, etc. The battery can 11 may have, for example, an almost hollow cylindrical shape. More specifically, the battery can 11 may have a hollow structure in which one end of the battery can 11 is closed and the other end thereof is open. The battery can 11 may be made, for example, of one or more of iron (Fe), aluminum (Al), an alloy thereof, and the like. It is to be noted that a surface of the battery can 11 may be plated with a metal material such as nickel (Ni). The pair of insulating plates 12 and 13 extend perpendicularly to a spirally wound periphery surface of the spirally wound electrode body 20 and is arranged to sandwich the spirally wound electrode body 20 in between.

At the open end of the battery can 11, a battery cover 14, a safety valve mechanism 15, and a positive temperature coefficient device (a PTC device) 16 are attached by being swaged with a gasket 17. Thereby, the battery can 11 is hermetically sealed. The safety valve mechanism 15 and the PTC device 16 are provided inside the battery cover 14. The safety valve mechanism 15 is electrically connected to the battery cover 14 via the PTC device 16.

The battery cover 14 may be made, for example, of a material similar to that of the battery can 11.

The safety valve mechanism 15 is a safety mechanism that interrupts a current in accordance with an internal pressure of the battery can 11. More specifically, the safety valve mechanism 15 allows a disk plate 15A to invert and thereby cuts electric connection between the battery cover 14 and the spirally wound electrode body 20 when the internal pressure of the battery can 11 increases up to a certain pressure or higher. Accordingly, trouble such as heat generation becomes less likely to occur. A reason for the increase in the internal pressure of the battery can 11 may be, for example, internal short-circuit or heating of the secondary battery, etc.

The PTC device 16 prevents abnormal heat generation resulting from a large current. As temperature rises, resistance of the PTC device 16 increases accordingly.

The gasket 17 may be made, for example, of one or more of insulating materials. It is to be noted that a surface of the gasket 17 may be coated with asphalt or the like.

The spirally wound electrode body 20 is an electrode structure that includes main components (such as a cathode 21, an anode 22, and a separator 23) in the secondary battery. The spirally wound electrode body 20 may be configured, for example, of the cathode 21 and the anode 22 that face each other with the separator 23 in between and are spirally wound. It is to be noted that, for example, a center pin 24 may be inserted in the center of the spirally wound electrode body 20 (in a space provided in the center of the spirally wound electrode body 20). However, the center pin 24 may not be provided.

A cathode lead 25 is connected to the cathode 21. The cathode lead 25 may be made, for example, of one or more of conductive materials such as aluminum. An anode lead 26 is connected to the anode 22. The anode lead 26 may be made, for example, of one or more of conductive materials such as nickel. The cathode lead 25 is connected to the safety valve mechanism 15, and is electrically connected to the battery cover 14. The anode lead 26 is connected to the battery can 11, and therefore, is electrically connected to the battery can 11. A connection method for each of the cathode lead 25 and the anode lead 26 may be, for example, a welding method.

1-1-1. Cathode

The cathode 21 has a cathode active material layer 21B on one surface or both surfaces of a cathode current collector 21A. The cathode current collector 21A may be made, for example, of one or more of conductive materials such as aluminum, nickel, and stainless steel.

The cathode active material layer 21B contains, as a cathode active material, one or more of cathode materials capable of inserting and extracting lithium. It is to be noted that the cathode active material layer 21B may further contain one or more of other materials such as a cathode binder and a cathode electric conductor.

The cathode material may be preferably a lithium-containing compound, since high energy density is achieved thereby. Examples of the lithium-containing compound may include a lithium-transition-metal composite oxide and a lithium-transition-metal-phosphate compound. The lithium-transition-metal composite oxide is an oxide containing lithium and one or more transition metal elements as constituent elements. The lithium-transition-metal-phosphate compound is a phosphate compound containing lithium and one or more transition metal elements as constituent elements. In particular, the transition metal element may be preferably one or more of cobalt (Co), nickel, manganese (Mn), iron (Fe), and the like, since a higher voltage is achieved thereby. The chemical formula thereof may be expressed, for example, by LiₓM1O₂ or Li_{y}M2PO₄. In the formulas, M1 and M2 represent one or more transition metal elements. Values of x and y vary according to the charge and discharge state, and may satisfy, for example, 0.05<=x<=1.10 and 0.05<=y<=1.10.

Examples of the lithium-transition-metal composite oxide may include LiCoO₂, LiNiO₂, and a lithium-nickel-based composite oxide represented by the following Formula (1). Examples of the lithium-transition-metal-phosphate compound may include LiFePO₄ and LiFe₁₋ᵤMnᵤPO₄(u<1). One reason for this is because a high battery capacity is achieved and superior cycle characteristics and the like are achieved thereby.

LiNi_{1-z}M_{z}O₂ (1)

(M is one or more of cobalt, manganese, iron, aluminum, vanadium (V), tin (Sin), magnesium (Mg), titanium (Ti), strontium (Sr), calcium (Ca), zirconium (Zr), molybdenum (Mo), technetium (Tc), ruthenium (Ru), tantalum (Ta), tungsten (W), rhenium (Re), ytterbium (Yb), copper (Cu), zinc (Zn), barium (Ba), boron (B), chromium (Cr), silicon (Si), gallium (Ga), phosphorus (P), antimony (Sb), and niobium (Nb). z satisfies 0.005<z<0.5.)

Other than the above-described materials, the cathode material may be, for example, one or more of an oxide, a disulfide, a chalcogenide, a conductive polymer, and the like. Examples of the oxide may include titanium oxide, vanadium oxide, and manganese dioxide. Examples of the disulfide may include titanium disulfide and molybdenum sulfide. Examples of the chalcogenide may include niobium selenide. Examples of the conductive polymer may include sulfur, polyaniline, and polythiophene. However, the cathode material may be a material other than the above-mentioned materials.

Examples of the cathode binder may include one or more of synthetic rubbers, polymer materials, and the like. Examples of the synthetic rubber may include a styrene-butadiene-based rubber, a fluorine-based rubber, and ethylene propylene diene. Examples of the polymer material may include polyvinylidene fluoride and polyimide.

Examples of the cathode electric conductor may include one or more of carbon materials and the like. Examples of the carbon materials may include graphite, carbon black, acetylene black, and Ketjen black. However, the cathode electric conductor may be a metal material, a conductive polymer, or the like as long as the material has electric conductivity.

1-1-2. Anode

The anode 22 has an anode active material layer 22B on one surface or both surfaces of an anode current collector 22A.

The anode current collector 22A may be made, for example, of one or more of electrically-conductive materials such as copper, nickel, and stainless steel.

The surface of the anode current collector 22A may be preferably roughened. Thereby, due to a so-called anchor effect, adhesion characteristics of the anode active material layer 22B with respect to the anode current collector 22A are improved. In this case, it is enough that the surface of the anode current collector 22A in a region opposed to the anode active material layer 22B is roughened at minimum. Examples of roughening methods may include a method of forming fine particles by utilizing electrolytic treatment. The electrolytic treatment is a method of forming the fine particles on the surface of the anode current collector 22A with the use of an electrolytic method in an electrolytic bath to provide concavity and convexity on the surface of the anode current collector 22A. A copper foil fabricated by an electrolytic method is generally called “electrolytic copper foil.”

The anode active material layer 22B contains, as an anode active material, one or more of anode materials capable of inserting and extracting lithium. However, the anode active material layer 22B may further contain one or more of other materials such as an anode binder and an anode electric conductor. Details of the anode binder and the anode electric conductor may be, for example, similar to those of the cathode binder and the cathode electric conductor.

However, the chargeable capacity of the anode material may be preferably larger than the discharge capacity of the cathode 21 in order to prevent lithium metal from being unintentionally precipitated on the anode 22 in the middle of charge. That is, the electrochemical equivalent of the anode material capable of inserting and extracting lithium may be preferably larger than the electrochemical equivalent of the cathode 21.

Examples of the anode material may include one or more of carbon materials. One reason for this is because, in the carbon material, its crystal structure change at the time of insertion and extraction of lithium is extremely small, and therefore, the carbon material stably achieves high energy density. Another reason for this is because the carbon material serves as an anode electric conductor as well, and therefore, conductivity of the anode active material layer 22B improves.

Examples of the carbon material may include graphitizable carbon, non-graphitizable carbon, and graphite. However, the spacing of (002) plane in the non-graphitizable carbon may be preferably equal to or greater than 0.37 nm, and the spacing of (002) plane in graphite may be preferably equal to or smaller than 0.34 nm. More specifically, examples of the carbon material may include pyrolytic carbons, cokes, glassy carbon fiber, an organic polymer compound fired body, activated carbon, and carbon blacks. Examples of the cokes may include pitch coke, needle coke, and petroleum coke. The organic polymer compound fired body is obtained by firing (carbonizing) a polymer compound such as a phenol resin and a furan resin at an appropriate temperature. Other than the above-mentioned materials, the carbon material may be low crystalline carbon heat-treated at a temperature of about 1000 deg C. or lower or may be amorphous carbon. It is to be noted that the shape of the carbon material may be any of a fibrous shape, a spherical shape, a granular shape, and a scale-like shape.

Further, other examples of the anode material may include a material (a metal-based material) containing one or more of metal elements and metalloid elements as constitutional elements, since high energy density is achieved thereby.

The metal-based material may be a simple substance, an alloy, or a compound, may be two or more thereof, or may have one or more phases thereof in part or all thereof. “Alloy” includes a material containing one or more metal elements and one or more metalloid elements, in addition to a material configured of two or more metal elements. Further, the “alloy” may contain a nonmetallic element. Examples of the structure thereof may include a solid solution, a eutectic crystal (eutectic mixture), an intermetallic compound, and a structure in which two or more thereof coexist.

Examples of the foregoing metal elements and the foregoing metalloid elements may include one or more of metal elements and metalloid elements capable of forming an alloy with lithium. Specific examples thereof may include magnesium, boron, aluminum, gallium, indium (In), silicon, germanium (Ge), tin (Sn), lead (Pb), bismuth (Bi), cadmium (Cd), silver (Ag), zinc, hafnium (Hf), zirconium, yttrium (Y), palladium (Pd), and platinum (Pt).

In particular, silicon, tin, or both may be preferable, since silicon and tin have a superior ability of inserting and extracting lithium, and therefore, achieve high energy density.

A material containing silicon, tin, or both as constituent elements may be any of a simple substance, an alloy, and a compound of silicon, may be any of a simple substance, an alloy, and a compound of tin, may be two or more thereof, or may have one or more phases thereof in part or all thereof. It is to be noted that “simple substance” merely refers to a general simple substance (a small amount of impurity may be therein contained), and does not necessarily refer to a purity 100% simple substance.

The alloys of silicon may contain, for example, one or more of elements such as tin, nickel, copper, iron, cobalt, manganese, zinc, indium, silver, titanium, germanium, bismuth, antimony, and chromium, as a constituent element other than silicon. The compounds of silicon may contain, for example, one or more of carbon (C), oxygen (O), and the like as constituent elements other than silicon. It is to be noted that, for example, the compounds of silicon may contain one or more of the series of elements described for the alloys of silicon, as constituent elements other than silicon.

Specific examples of the alloys of silicon and the compounds of silicon may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v<=2), and LiSiO. v in SiOᵥ may be in a range of 0.2<v<1.4.

The alloys of tin may contain, for example, one or more of elements such as silicon, nickel, copper, iron, cobalt, manganese, zinc, indium, silver, titanium, germanium, bismuth, antimony, and chromium, as constituent elements other than tin. The compounds of tin may contain, for example, one or more of elements such as carbon and oxygen as constituent elements other than tin. It is to be noted that the compounds of tin may contain, for example, one or more of the series of elements described for the alloys of tin, as constituent elements other than tin.

Specific examples of the alloys of tin and the compounds of tin may include SnO_{w} (0<w<=2), SnSiO₃, LiSnO, and Mg₂Sn.

In particular, the material containing tin as a constituent element may be preferably, for example, a material containing a second constituent element and a third constituent element in addition to tin as a first constituent element. Examples of the second constituent element may include one or more of elements such as cobalt, iron, magnesium, titanium, vanadium, chromium, manganese, nickel, copper, zinc, gallium, zirconium, niobium, molybdenum, silver, indium, cesium (Ce), hafnium (Hf), tantalum, tungsten, bismuth, and silicon. Examples of the third constituent element may include one or more of boron, carbon, aluminum, phosphorus, and the like. One reason for this is because a high battery capacity, superior cycle characteristics, and the like are achieved thereby.

In particular, a material (SnCoC-containing material) containing tin, cobalt, and carbon as constituent elements may be preferable. In the SnCoC-containing material, for example, the content of carbon may be from 9.9 mass % to 29.7 mass % both inclusive, and the ratio of contents of tin and cobalt (Co/(Sn+Co)) may be from 20 mass % to 70 mass % both inclusive, since high energy density is achieved thereby.

The SnCoC-containing material may preferably have a phase containing tin, cobalt, and carbon. Such a phase may be preferably low-crystalline or amorphous. The phase is a phase (a reaction phase) capable of reacting with lithium. Therefore, due to existence of the reaction phase, superior characteristics are achieved. A half bandwidth (a diffraction angle 2 theta) of a diffraction peak obtained by X-ray diffraction of the reaction phase may be preferably equal to or greater than 1 deg in the case where CuK alpha ray is used as a specific X ray, and the insertion rate is 1 deg/min. One reason for this is because lithium is more smoothly inserted and extracted thereby, and reactivity with the electrolytic solution is decreased. It is to be noted that, in some cases, the SnCoC-containing material may include a phase containing a simple substance or part of the respective constituent elements in addition to the low-crystalline phase or the amorphous phase.

Whether or not the diffraction peak obtained by the X-ray diffraction corresponds to the reaction phase capable of reacting with lithium is allowed to be easily determined by comparison between X-ray diffraction charts before and after electrochemical reaction with lithium. For example, if the position of the diffraction peak after electrochemical reaction with lithium is changed from the position of the diffraction peak before the electrochemical reaction with lithium, the obtained diffraction peak corresponds to the reaction phase capable of reacting with lithium. In this case, for example, the diffraction peak of the low crystalline reaction phase or the amorphous reaction phase is seen in a range of 2 theta=from 20 deg to 50 deg both inclusive. Such a reaction phase may have, for example, the foregoing respective constituent elements, and the low crystalline or amorphous structure thereof possibly results from existence of carbon mainly.

In the SnCoC-containing material, part or all of carbon as a constituent element may be preferably bonded to a metal element or a metalloid element as other constituent element, since cohesion or crystallization of tin and/or the like is suppressed thereby. The bonding state of elements is allowed to be checked, for example, by an X-ray photoelectron spectroscopy method (XPS). In a commercially-available device, for example, Al—K alpha ray, Mg—K alpha ray, or the like may be used as a soft X ray. In the case where part or all of carbons are bonded to a metal element, a metalloid element, or the like, the peak of a synthetic wave of is orbit of carbon (C1s) is shown in a region lower than 284.5 eV. It is to be noted that, in the device, energy calibration is made so that the peak of 4f orbit (Au4f) of gold atom (Au) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of carbon in the SnCoC-containing material. Therefore, for example, analysis may be made with the use of commercially-available software to isolate both peaks from each other. In the waveform analysis, the position of the main peak existing on the lowest bound energy side is the energy standard (284.8 eV).

It is to be noted that the SnCoC-containing material is not limited to the material (SnCoC) configured of only tin, cobalt, and carbon as constituent elements. The SnCoC-containing material may further contain, for example, one or more of silicon, iron, nickel, chromium, indium, niobium, germanium, titanium, molybdenum, aluminum, phosphorus, gallium, bismuth, and the like as constituent elements, in addition to tin, cobalt, and carbon.

Other than the SnCoC-containing material, a material (SnCoFeC-containing material) containing tin, cobalt, iron, and carbon as constituent elements may be also preferable. The composition of the SnCoFeC-containing material may be any composition. To give an example, when the content of iron is set small, the content of carbon may be from 9.9 mass % to 29.7 mass % both inclusive, the content of iron may be from 0.3 mass % to 5.9 mass % both inclusive, and the ratio of contents of tin and cobalt (Co/(Sn+Co)) may be from 30 mass % to 70 mass % both inclusive. Further, when the content of iron is set larger, the content of carbon is from 11.9 mass % to 29.7 mass % both inclusive, the ratio of contents of tin, cobalt, and iron ((Co+Fe)/(Sn+Co+Fe)) is from 26.4 mass % to 48.5 mass % both inclusive, and the ratio of contents of cobalt and iron (Co/(Co+Fe)) is from 9.9 mass % to 79.5 mass % both inclusive. One reason for this is because, in such compositions, high energy density is achieved. The physical properties (such as half bandwidth) of the SnCoFeC-containing material are similar to those of the SnCoC-containing material described above.

Other than the above-mentioned materials, the anode material may be, for example, one or more of a metal oxide, a polymer compound, and the like. Examples of the metal oxide may include iron oxide, ruthenium oxide, and molybdenum oxide. Examples of the polymer compound may include polyacetylene, polyaniline, and polypyrrole.

In particular, the anode material may preferably include both the carbon material and the metal-based material for the following reason.

The metal-based material, in particular, a material including silicon, tin, or both as constituent elements has an advantage of large theoretical capacity but may have a concern that such a material may be easily expanded or contracted at the time of electrode reaction. On the other hand, the carbon material has a concern that carbon material has small theoretical capacity but has an advantage that the carbon material is less likely to be expanded or contracted at the time of electrode reaction. Therefore, by using both of the carbon material and the metal-based material, the expansion and contraction of the anode active material at the time of electrode reaction is suppressed while a large theoretical capacity (in other words, a large battery capacity) is achieved.

The anode active material layer 22B may be formed, for example, by one or more of a coating method, a vapor-phase deposition method, a liquid-phase deposition method, a spraying method, and a firing method (sintering method). The coating method may be a method in which, for example, after a particulate (powder) anode active material is mixed with an anode binder and/or the like, the mixture is dispersed in a solvent such as an organic solvent, and the anode current collector 22A is coated with the resultant. Examples of the vapor-phase deposition method may include a physical deposition method and a chemical deposition method. More specifically, examples thereof may include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase deposition method may include an electrolytic plating method and an electroless plating method. The spraying method is a method in which the anode active material in a fused state or a semi-fused state is sprayed to the anode current collector 22A. The firing method may be, for example, a method in which after the anode current collector 22A is coated with the mixture diffused in the solvent by a coating method, heat treatment is performed at a temperature higher than the melting point of the anode binder and/or the like. Examples of the firing method may include an atmosphere firing method, a reactive firing method, and a hot press firing method.

In the secondary battery, as described above, in order to prevent lithium metal from being unintentionally precipitated on the anode 22 in the middle of charge, the electrochemical equivalent of the anode material capable of inserting and extracting lithium may be preferably larger than the electrochemical equivalent of the cathode. Further, in the case where an open circuit voltage (a battery voltage) at the time of completely-charged state is equal to or greater than 4.25 V, the extraction amount of lithium per unit mass is larger than that in the case where the open circuit voltage is 4.20 V even if the same cathode active material is used. Therefore, amounts of the cathode active material and the anode active material are adjusted taking into consideration that tendency. Thus, high energy density is achieved.

1-1-3. Separator

The separator 23 separates the cathode 21 from the anode 22, and passes lithium ions while preventing current short circuit resulting from contact of both electrodes. The separator 23 may be, for example, a porous film including one or more of synthetic resin, ceramics, and the like. The separator 23 may be a laminated film in which two or more types of porous films are laminated. The synthetic resin may be one or more of polytetrafluoroethylene, polypropylene, and polyethylene.

In particular, the separator 23 may include, for example, the above-described porous film (base material layer) and a polymer compound layer provided on one surface or both surfaces of the foregoing base material layer. One reason for this is because adhesion characteristics of the separator 23 with respect to the cathode 21 and the anode 22 are improved thereby, and therefore, skewness of the spirally wound electrode body 20 is suppressed. Therefore, a decomposition reaction of the electrolytic solution is suppressed, and liquid leakage of the electrolytic solution with which the base material layer is impregnated is suppressed. Accordingly, even if charge and discharge are repeated, the resistance is less likely to be increased, and battery swollenness is suppressed.

The polymer compound layer may contain, for example, a polymer material such as polyvinylidene fluoride, since such a polymer material has superior physical strength and is electrochemically stable. However, the polymer material may be a material other than polyvinylidene fluoride. When forming the polymer compound layer, for example, after a solution in which the polymer material is dissolved is prepared, the base material layer is coated with the solution, and the resultant is subsequently dried. Alternatively, the base material layer may be soaked in the solution and may be subsequently dried.

1-1-4. Electrolytic Solution

The spirally wound electrode body 20 is impregnated with the electrolytic solution that is a liquid electrolyte. Specifically, with the electrolytic solution, a plurality of components (such as the cathode 21, the anode 22, and the separator 23) forming the spirally wound electrode body 20 are impregnated.

The electrolytic solution contains a solvent and an electrolyte salt. It is to be noted that the electrolytic solution may further contain one or more of other materials such as an additive.

The solvent contains one or more of non-aqueous solvents such as an organic solvent. An electrolytic solution that includes the non-aqueous solvent is a so-called non-aqueous electrolytic solution.

Examples of the non-aqueous solvents may include a cyclic ester carbonate, a chain ester carbonate, lactone, a chain carboxylic ester, and nitrile, since a superior battery capacity, superior cycle characteristics, superior conservation characteristics, and the like are thereby achieved. Examples of the cyclic ester carbonate may include ethylene carbonate, propylene carbonate, and butylene carbonate. Examples of the chain ester carbonate may include dimethyl carbonate, diethyl carbonate, ethyl methyl carbonate, and methylpropyl carbonate. Examples of the lactone may include gamma-butyrolactone and gamma-valerolactone. Examples of the carboxylic ester may include methyl acetate, ethyl acetate, methyl propionate, ethyl propionate, methyl butyrate, methyl isobutyrate, methyl trimethylacetate, and ethyl trimethylacetate. Examples of the nitrile may include acetonitrile, glutaronitrile, adiponitrile, methoxyacetonitrile, and 3-methoxypropionitrile.

In addition thereto, the non-aqueous solvent may be, for example, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, or dimethyl sulfoxide, since thereby, a similar advantage is achieved.

In particular, one or more of ethylene carbonate, propylene carbonate, dimethyl carbonate, diethyl carbonate, and ethyl methyl carbonate may be preferable, since a further superior battery capacity, further superior cycle characteristics, further superior conservation characteristics, and the like are thereby obtained. In this case, a combination of a high viscosity (high dielectric constant) solvent (for example, specific dielectric constant epsilon>=30) such as ethylene carbonate and propylene carbonate and a low viscosity solvent (for example, viscosity<=1 mPa*s) such as dimethyl carbonate, ethylmethyl carbonate, and diethyl carbonate may be more preferable. One reason for this is because the dissociation property of the electrolyte salt and ion mobility are thereby improved.

In particular, the non-aqueous solvent may be preferably one or more of an unsaturated cyclic ester carbonate, a halogenated ester carbonate, sultone (cyclic sulfonic ester), an acid anhydride, and the like. One reason for this is because, in this case, chemical stability of the electrolytic solution is improved. The unsaturated cyclic ester carbonate is a cyclic ester carbonate including one or more unsaturated carbon bonds (carbon-carbon double bonds or carbon-carbon triple bonds). Examples of the unsaturated cyclic ester carbonate may include vinylene carbonate, vinylethylene carbonate, and methyleneethylene carbonate. The halogenated ester carbonate is a cyclic ester carbonate having one or more halogens as constituent elements or a chain ester carbonate having one or more halogens as constituent elements. Examples of the cyclic halogenated ester carbonate may include 4-fluoro-1,3-dioxolane-2-one and 4,5-difluoro-1,3-dioxolane-2-one. Examples of the chain halogenated ester carbonate may include fluoromethyl methyl carbonate, bis (fluoromethyl) carbonate, and difluoromethyl methyl carbonate. Examples of the sultone may include propane sultone and propene sultone. Examples of the acid anhydrides may include a succinic anhydride, an ethane disulfonic anhydride, and a sulfobenzoic anhydride. However, the non-aqueous solvent may be other material.

The electrolyte salt may contain, for example, one or more of salts such as lithium salt. However, the electrolyte salt may contain salt other than the lithium salt. Examples of the salt other than the lithium salt may include salt of light metal salt other than lithium.

Examples of the lithium salts may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr), since a superior battery capacity, superior cycle characteristics, superior conservation characteristics, and the like are achieved thereby.

In particular, one or more of LiPF₆, LiBF₄, LiClO₄, and LiAsF₆ may be preferable, and LiPF₆ may be more preferable, since the internal resistance is thereby lowered, and therefore, a higher effect is achieved. However, the electrolyte salt may be other salt.

Although the content of the electrolyte salt is not particularly limited, the content thereof may be preferably from 0.3 mol/kg to 3.0 mol/kg both inclusive with respect to the solvent, since high ion conductivity is achieved thereby.

1-2. Means for Safety

In the secondary battery, the following means for safety is provided in order to secure safety.

1-2-1. Non-Impregnation Solution Ratio

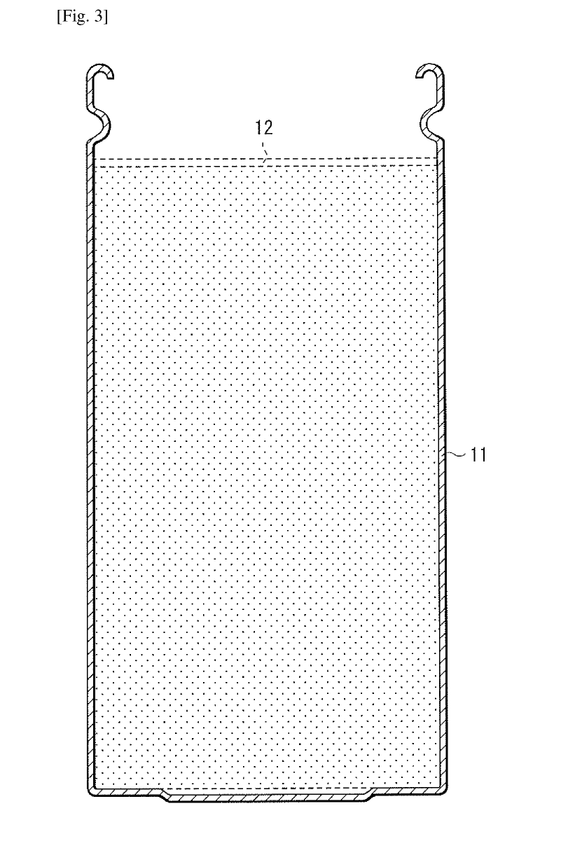

FIG. 3 illustrates a cross-sectional configuration corresponding to FIG. 1 for explaining the internal volume of the battery can 11.

In order to secure operation reliability of the safety valve mechanism 15, specifically, in order to increase operation capability of the safety valve mechanism 15 when the internal pressure of the battery can 11 increases, an amount of the electrolytic solution with which the spirally wound electrode body 20 is not impregnated is made appropriate.

More specifically, the electrolytic solution includes impregnation electrolytic solution with which the spirally wound electrode body 20 is impregnated, and non-impregnation electrolytic solution with which the spirally wound electrode body 20 is not impregnated. In other words, part (the impregnation electrolytic solution) of the electrolytic solution is used to impregnate the cathode 21, the anode 22, the separator 23, and the like that configure the spirally wound electrode body 20. On the other hand, the rest (the non-impregnation electrolytic solution) of the electrolytic solution which is not used to impregnate the spirally wound electrode body 20 remains inside the battery can 11, and the non-impregnation electrolytic solution is present in a space (or a gap) 11S caused inside the battery can 11. The space 11S may be, for example, a space caused between an inner wall of the battery can 11 and the spirally wound electrode body 20, a space caused between the spirally wound electrode body 20 and the center pin 24, etc.

The reason why the non-impregnation electrolytic solution is present inside the battery can 11 is not particularly limited. The non-impregnation electrolytic solution may be part of the electrolytic solution with which the spirally wound electrode body 20 has been impregnated, that has been released to the outside. Alternatively, the non-impregnation electrolytic solution may be provided additionally inside the battery can 11 after the spirally wound electrode body 20 that has already been impregnated with the electrolytic solution is contained inside the battery can 11.

In this example, the volume of the non-impregnation electrolytic solution is a volume that allows the internal pressure of the battery can 11 to be intentionally increased up to a pressure that allows the safety valve mechanism 15 to be operate by utilizing boost of a pressure resulting from volatilization of the non-impregnation electrolytic solution when the secondary battery becomes in an over-load state.

More specifically, in the secondary battery in a charged state (where the battery voltage is 4.2 V), the ratio (a non-impregnation solution ratio) of the volume (cm³) of the non-impregnation electrolytic solution to the volume (the internal content: cm³) of the battery can 11 is from 0.31% to 7.49% both inclusive. The non-impregnation solution ratio (%) is represented by (the volume of the non-impregnation electrolytic solution/the internal volume of the battery can 11)*100.

The volume of the non-impregnation electrolytic solution (or the non-impregnation solution ratio) satisfies the above-described condition because, with respect to an amount of space (the internal volume of the battery can 11) that allows gas of an amount necessary for the operation of the safety valve mechanism 15 to be contained therein, an amount of solution (the volume of the non-impregnation electrolytic solution) that allows generation of that amount of gas is made appropriate. Accordingly, in the secondary battery in the over-load state, the non-impregnation electrolytic solution volatizes (becomes gas) effectively in accordance with an increase in internal temperature of the secondary battery. Therefore, the internal pressure of the battery can 11 is also increased effectively. In other words, when an abnormal incidence occurs, the safety valve mechanism 15 becomes easier to operate sensitively in accordance to the increase in the internal pressure of the battery can 11. Moreover, since the volume of the impregnation electrolytic solution that contributes to the battery characteristics is secured, the discharge capacity is less likely to be decreased even in the over-load state. Therefore, a possibility that the safety valve mechanism 15 operates when the abnormal incidence occurs is increased while the battery characteristics are secured.

In detail, when the non-impregnation solution ratio is smaller than 0.31%, the amount of solution (the volume of the non-impregnation electrolytic solution) used for generating gas becomes excessively small with respect to the amount of the solution (the volume of the impregnation electrolytic solution) used for the charge and discharge reactions. In this case, the discharge capacity is less likely to be decreased since the solution amount of the impregnation electrolytic solution is secured. However, the possibility that the safety valve mechanism 15 operates when the abnormal incidence occurs is decreased since the amount of generation of gas is insufficient.

On the other hand, when the non-impregnation solution ratio is larger than 7.49%, the amount of solution used for the charge and discharge reactions becomes excessively small with respect to the amount of the solution used for generation of gas. In this case, the possibility that the safety valve mechanism 15 operates when the abnormal incidence occurs is increased since the amount of generation for gas is secured. However, the resistance is increased and the discharge capacity is decreased since the solution amount of the impregnation electrolytic solution is insufficient.

Accordingly, in a case where the non-impregnation solution ratio does not satisfy the above-described condition, the operation possibility of the safety valve mechanism 15 is decreased when the decrease in the discharge capacity is suppressed, and the decrease in the discharge capacity is accelerated when the operation possibility of the safety valve mechanism 15 is increased. Hence, a relationship of so-called trade-off is established between battery characteristics and safety.

On the other hand, when the non-impregnation solution ratio satisfies the above-described condition, the amount of the solution that contributes to generation of gas is secured, and the amount of the solution that contributes to the battery characteristics is also secured. Therefore, the above-described trade-off relationship is resolved. Accordingly, the possibility that the safety valve mechanism 15 operates when the abnormal incidence occurs is increased while the decrease in the discharge capacity is suppressed. Therefore, both improvement in battery characteristics and improvement in securing safety are achieved.

In particular, the secondary battery potentially has a possibility of occurrence of trouble such as heat generation for the following reason.

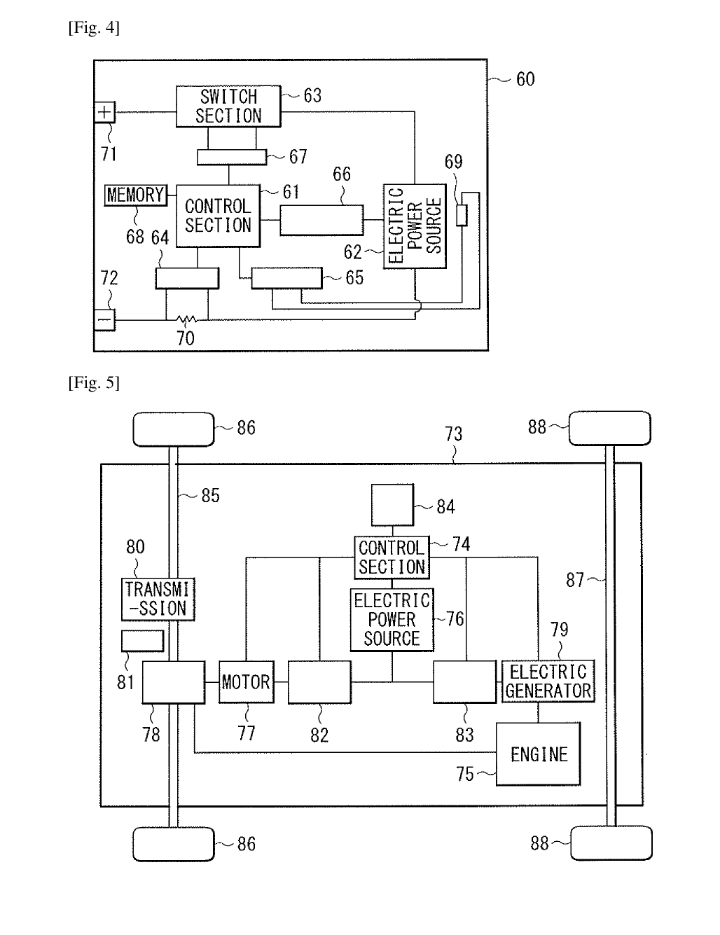

As a form of using the secondary battery, there are a form of using one secondary battery (a single battery) as it is, and a form of using two or more secondary batteries in combination (an assembled battery). The secondary battery described with reference to FIGS. 1 to 3 is an example of the battery cell. An example of the assembled battery will be described later (with reference to FIG. 4).

In the assembled battery that includes a plurality of secondary batteries, the characteristics tend to vary between the secondary batteries. Such characteristics may include, for example, battery capacity, internal resistance, etc. In the assembled battery, when part of the secondary batteries, more specifically, secondary batteries having high resistance or low capacity become in an over-load state due to degradation in the above-described characteristics, a large current flows through the entire assembled battery. Therefore, the separator 23 is shut down. In this case, the secondary battery having particularly remarkable degradation is inverted in polarity. Therefore, such a secondary battery is over-discharged to have a negative potential. Accordingly, the separator 23 is deformed or broken in accordance with the increase in the internal temperature of the secondary battery. Therefore, trouble such as heat generation may occur.

The battery cell is not inverted in polarity, unlike the above-described assembled battery. However, over-discharge may occur in a manner similar to that in the assembled battery in some cases. Specifically, in a case where the secondary battery that has been discharged until the battery voltage becomes 0 V becomes in the over-load state due to a factor such as external short circuit, when the internal resistance of the secondary battery is extremely increased, the separator 23 is shut down. Accordingly, the separator 23 may be deformed or broken in accordance with the increase in the internal temperature of the secondary battery, as in the assembled battery. Therefore, trouble such as heat generation may occur.

However, when the non-impregnation solution ratio satisfies the above-described condition, the possibility that the safety valve mechanism 15 operates when the abnormal incidence occurs is increased while the battery characteristics are secured. Therefore, both improvement in battery characteristics and improvement in securing safety are achieved in the secondary battery that potentially has the above-described issue.

The internal volume of the battery can 11 that is used for calculating the non-impregnation solution ratio is a space, out of a space inside the battery can 11, in which the spirally wound electrode body 20 is contained, as shown in FIGS. 1 and 3. More specifically, the internal volume is a space, out of the space inside the battery can 11, surrounded by the inner wall of the battery can 11 and the insulating plate 12. The space corresponding to the internal volume is shaded in FIG. 3. It is to be noted that a portion in which the insulating plate 12 has been present is shown by a dashed line in FIG. 3.

The procedure of determining the internal volume of the battery can 11 may be, for example, as follows. First, the secondary battery shown in FIG. 1 is disassembled, and the battery cover 14, the spirally wound electrode body 20, etc. are taken out from the inside of the battery can 11. Accordingly, the battery can 11 shown in FIG. 3 is achieved. Subsequently, the inside of the battery can 11 is washed with the use of, for example, an organic solvent to remove residuals of the electrolytic solution and the like. Thereafter, water is provided inside the battery can 11. In this case, out of the space inside the battery can 11, the space corresponding to the above-described internal volume is filled with the water. Lastly, the water inside the battery can 11 is transferred to a graduated cylinder and the volume of the transferred water, i.e., the internal volume of the battery can 11 is determined therefrom.

The procedures for determining the volume of the non-impregnation electrolytic solution may be as follows, for example. First, the secondary battery is charged. In this case, the secondary battery is charged with a constant current of 1 C until the voltage reaches its upper limit of 4.2 V under an ambient temperature environment (23 deg C.), and further, the secondary battery is charged at a constant voltage of 4.2 V until the current reaches 100 mA under the same environment. It is to be noted that “1C” is a current value that allows the battery capacity (theoretical capacity) to be completely discharged in one hour. Subsequently, a weight (g) of the charged secondary battery is measured. Subsequently, part of a side surface of the battery can 11 is cut with the use of a tool such as a nipper to provide, in the battery can 11, an incision for taking out the non-impregnation electrolytic solution. A size of the incision is not particularly limited, but may be about 1 cm, for example. Subsequently, the secondary battery is placed in a centrifuge apparatus, and the non-impregnation electrolytic solution is centrifugalized from the secondary battery. In this centrifugation process, the non-impregnation electrolytic solution contained inside the battery can 11 is released to the outside through the incision by utilizing centrifugal force. The condition of the centrifugation is not particularly limited, but may be, for example, rotation speed=2000 rpm and rotation time=3 minutes. Subsequently, a weight (g) of the secondary battery after the centrifugation is measured, and then, a weight (g) of the non-impregnation electrolytic solution is calculated as the weight (g) of the non-impregnation electrolytic solution=the weight of the secondary battery before the centrifugation−the weight of the secondary battery after the centrifugation. Finally, the weight of the non-impregnation electrolytic solution is divided by specific gravity (g/cm³) to calculate the volume (cm³) thereof. It is to be noted that a value of the specific gravity varies little even if the composition of the non-impregnation electrolytic solution, specifically, a type of the solvent, a type of the electrolyte salt, etc. are varied.

It is to be noted that one reason why the value of the battery voltage (=4.2 V) is set when the appropriate condition of the non-impregnation solution ratio is defined is because the amount of the non-impregnation electrolytic solution may vary in accordance with the state (a depth of the charge) of the secondary battery. Accordingly, in order to stably and accurately calculate the non-impregnation solution ratio, it may be necessary to set a reference (a state of the secondary battery to be a reference) for calculating the volume of the non-impregnation electrolytic solution. In this example, 4.2 V is adopted assuming the battery voltage of the fully-charged secondary battery.

More specifically, in the secondary battery in the discharged state, part of the electrolytic solution with which the spirally wound electrode body 20 is impregnated is less likely to be released to the outside. Therefore, a maximum value of the volume of the non-impregnation electrolytic solution tends to decrease. In this case, the absolute amount of the non-impregnation electrolytic solution is small. Therefore, it may be difficult to calculate the volume of the non-impregnation electrolytic solution, and an error in measurement may be larger. Also, a difference in volume of the non-impregnation electrolytic solution may less likely to be caused between a plurality of secondary batteries when the absolute amount of the non-impregnation electrolytic solution is small.

On the other hand, in the secondary battery in the charged state, part of the electrolytic solution with which the spirally wound electrode body 20 is impregnated is easily released to the outside. Therefore, the maximum value of the volume of the non-impregnation electrolytic solution tends to increase. In this case, the absolute amount of the non-impregnation electrolytic solution is large. Therefore, it may be easier to measure the volume of the non-impregnation electrolytic solution, and the error in measurement becomes smaller. Also, a difference in volume of the non-impregnation electrolytic solution may be easier to be caused between a plurality of secondary batteries when the absolute amount of the non-impregnation electrolytic solution is large.

In order to determine the non-impregnation solution ratio with stability and favorable reproducibility and in order to accurately compare the non-impregnation solution ratios between a plurality of secondary batteries, the value of the battery voltage of the secondary battery is not particularly limited when the secondary battery is in the charged state. However, in this example, the battery voltage of 4.2 V of the secondary battery in the charged state is used as a reference taking into consideration the upper limit of a general charge voltage of a secondary battery, etc. In this case, the charge condition used until the secondary battery becomes in the charged state, more specifically, a condition such as a charge current is not particularly limited.

1-2-2. Melting Point of Separator

The configuration of the separator 23 has been already described in detail. However, the melting point (melt-down temperature) and the thickness of the separator 23 are not particularly limited. One reason for this is because both improvement in battery characteristics and improvement in securing safety are achieved without depending on the melting point and the thickness of the separator 23 if the above-described condition related to the non-impregnation solution ratio is satisfied.

In particular, the melting point of the separator 23 may be preferably 160 deg C. or higher. One reason for this is because the separator 23 is less likely to be deformed or broken when the internal temperature of the secondary battery increases, and therefore, occurrence of internal short circuit, etc. are suppressed. Accordingly, the internal temperature is less likely to be increased excessively. Therefore, trouble such as heat generation in the secondary battery may be further less likely to occur. It is to be noted that the melting point of the separator 23 is allowed to be measured, for example, by differential scanning calorimetry (DSC).

Moreover, the thickness of the separator 23 may be preferably from 5 micrometers to 25 micrometers both inclusive. One reason for this is because physical strength of the separator 23, etc. are secured without preventing lithium ion from passing through. Accordingly, trouble such as heat generation, etc. in the secondary battery is less likely to occur while superior battery characteristics are retained.

1-2-3. Gas Generating Substance

The configuration of the anode active material layer 22B has been already described in detail. However, the type of other material (additive) contained in the anode active material layer 22B is not particularly limited. One reason for this is because both improvement in battery characteristics and improvement in securing safety are achieved without depending on presence or absence of the additive if the above-described appropriate condition related to the non-impregnation solution ratio is satisfied.

In particular, the anode active material layer 22B may preferably include one or more of materials (gas generating substances) that electrochemically generate gas at an anode potential (an anode potential with respect to lithium metal) of 3 V or higher. One reason for this is because the amount of gas necessary for allowing the safety valve mechanism 15 to operate is increased thereby, and therefore, the operation probability of the safety valve mechanism 15 is further increased.

The gas generating substance generates gas at the anode potential of 3 V or higher because an oxidation decomposition reaction of the gas generating substance is induced at such an anode potential. Therefore, gas is allowed to be generated intentionally by utilizing the gas generating substance.

The type of the gas generating substance is not particularly limited as long as the gas generating substance is a material that is capable of generating gas at the above-described anode potential. In particular, the gas generating substance may be preferably one or more of salts of acid, and more specifically, may be preferably one or more of carbonates and phosphates, since such a material is easily available and achieves stable and sufficient gas release characteristics.

Examples of the carbonates may include alkali metal carbonate and alkaline-earth metal carbonate. Examples of the phosphate may include alkali metal phosphate and alkaline-earth phosphate.

More specifically, examples of the alkali metal carbonate may include lithium carbonate (Li₂CO₃), sodium carbonate (Na₂CO₃), and potassium carbonate (K₂CO₃). Examples of the alkaline-earth metal carbonate may include magnesium carbonate (MgCO₃) and calcium carbonate (CaCO₃). Examples of the alkali metal phosphate may include lithium phosphate (Li₃PO₃), sodium phosphate (Na₃PO₃), and potassium phosphate (K₃PO₃). Examples of the alkaline-earth metal phosphate may include magnesium phosphate (Mg₃(PO₄)₂) and calcium phosphate (Ca₃(PO₄)₂).

The form of the gas generating substance contained in the anode active material layer 22B is not particularly limited. Therefore, the gas generating substance may be mixed together with the anode active material, and thereby, may be contained in an anode mixture which will be described later. Alternatively, after the anode active material layer 22B is formed, a coating film containing the gas generating substance may be formed on a surface (a surface in contact with the separator 23) of the anode active material layer 22B. It goes without saying that the above-described forms may both be adopted.

In particular, the gas generating substance may be preferably contained in the anode mixture, since gas is allowed to be generated while the resistance of the anode 22 is suppressed. In detail, when a coating film is formed on the surface of the anode active material layer 22B, the resistance of the anode 22 is likely to increase since the coating film serves as a resistive layer. Therefore, the discharge capacity is likely to decrease when charge and discharge are performed repeatedly. In particular, when the formation amount of the coating film is increased in order to secure the gas generation amount, the resistance of the anode 22 is excessively increased. Therefore, the discharge capacity is extremely decreased. On the other hand, when the gas generating substance is dispersed in the anode active material layer 22B, the resistance of the anode 22 is less likely to be increased. Therefore, the discharge capacity is less likely to decrease even charge and discharge are performed repeatedly.

It is to be noted that the content of the gas generating substance in the anode active material layer 22B is not particularly limited. However, the content of the gas generating substance in the anode active material layer 22B may be preferably from 0.02 wt % to 3 wt % both inclusive since the content of the gas generating substance is not excessively large relative to the content of the anode active material. Therefore, the operation probability of the safety valve mechanism 15 is further increased while superior battery characteristics are maintained.

1-3. Operation

The secondary battery may operate, for example, as follows. At the time of charge, lithium ions extracted from the cathode 21 may be inserted in the anode 22 via the electrolytic solution. At the time of discharge, lithium ions extracted from the anode 22 may be inserted in the cathode 21 via the electrolytic solution.

1-4. Manufacturing Method

The secondary battery may be manufactured, for example, by the following procedure.

When the cathode 21 is fabricated, first, the cathode active material may be mixed with the cathode binder, the cathode electric conductor, and/or the like as necessary to prepare a cathode mixture. Subsequently, the cathode mixture is dispersed in an organic solvent or the like to obtain paste cathode mixture slurry. Subsequently, both surfaces of the cathode current collector 21A are coated with the cathode mixture slurry, which is dried to form the cathode active material layer 21B. Subsequently, the cathode active material layer 21B is compression-molded with the use of a roll pressing machine and/or the like while heating the cathode active material layer 21B as necessary. In this case, compression-molding may be repeated several times.

When the anode 22 is fabricated, the anode active material layer 22B is formed on the anode current collector 22A by a procedure almost similar to that of the cathode 21 described above. Specifically, an anode active material may be mixed with the anode binder, the anode electric conductor, and/or the like to prepare an anode mixture, which is subsequently dispersed in an organic solvent or the like to form paste anode mixture slurry. The gas generating substance may be contained in the anode mixture as necessary. Subsequently, both surfaces of the anode current collector 22A are coated with the anode mixture slurry, which is dried to form the anode active material layer 22B. Thereafter, the anode active material layer 22B is compression-molded with the use of a roll pressing machine and/or the like.

When the secondary battery is assembled, first, the cathode lead 25 is connected to the cathode current collector 21A by a welding method and/or the like, and the anode lead 26 is connected to the anode current collector 22A by a welding method and/or the like. Subsequently, the cathode 21 and the anode 22 are layered with the separator 23 in between and are spirally wound to fabricate the spirally wound electrode body 20. Thereafter, the center pin 24 is inserted in the center of the spirally wound electrode body 20. Subsequently, the spirally wound electrode body 20 is sandwiched between the pair of insulating plates 12 and 13, and is contained inside the battery can 11. In this case, the end tip of the cathode lead 25 is connected to the safety valve mechanism 15 by a welding method and/or the like, and the end tip of the anode lead 26 is connected to the battery can 11 by a welding method and/or the like. Subsequently, the electrolytic solution is injected to the inside of the battery can 11, and the spirally wound electrode body 20 is impregnated with the electrolytic solution. In this case, an injection amount of the electrolytic solution is adjusted so that the non-impregnation solution ratio satisfies the above-described condition. Further, the electrolytic solution may be additionally provided inside the battery can 11 as necessary so that the non-impregnation solution ratio satisfies the above-described condition. Lastly, at the open end of the battery can 11, the battery cover 14, the safety valve mechanism 15, and the PTC device 16 are fixed by being swaged with the gasket 17.

1-5. Functions and Effects

According to the secondary battery according to the embodiment of the present technology, the volume of the non-impregnation electrolytic solution is the above-described predetermined volume. More specifically, the non-impregnation solution ratio is from 0.31% to 7.49% both inclusive in a charged state (at the battery voltage of 4.2 V). In this case, the possibility that the safety valve mechanism 15 operates when the abnormal incidence occurs increases while decrease in the discharge capacity is suppressed in the secondary battery in the over-load state as described above. Accordingly, both improvement in battery characteristics and improvement in securing safety are achieved.

In particular, in the assembled battery that uses the secondary batteries according to the embodiment of the present technology, safety is secured without using an electronic component such as a fuse. Therefore, safety is secured easily at a low cost.

In the secondary battery according to the embodiment of the present technology, a further higher effect is achieved when the melting point of the separator 23 is 160 deg C. or higher, or the thickness of the separator 23 is from 5 micrometers to 25 micrometers both inclusive.

Moreover, a further higher effect is achieved when the anode active material layer 22B of the anode 22 contains the gas generating substance (such as a carbonate or a phosphate), and the content of the gas generating substance in the anode active material layer 22B is from 0.02 wt % to 3 wt % both inclusive.

2. Applications of Secondary Battery

Next, description is given of application examples of the foregoing secondary battery.

Applications of the secondary battery are not particularly limited as long as the secondary battery is applied to a machine, a device, an instrument, an apparatus, a system (collective entity of a plurality of devices and the like), or the like that is allowed to use the secondary battery as a driving electric power source, an electric power storage source for electric power storage, or the like. The secondary battery used as an electric power source may be a main electric power source (an electric power source used preferentially), or may be an auxiliary electric power source (an electric power source used instead of a main electric power source or used being switched from the main electric power source). In the case where the secondary battery is used as the auxiliary electric power source, the main electric power source type is not limited to the secondary battery.

Examples of applications of the secondary battery may include electronic apparatuses (including portable electronic apparatuses) such as a video camcorder, a digital still camera, a mobile phone, a notebook personal computer, a cordless phone, a headphone stereo, a portable radio, a portable television, and a portable information terminal. Further examples thereof may include a mobile lifestyle appliance such as an electric shaver; a storage device such as a backup electric power source and a memory card; an electric power tool such as an electric drill and an electric saw; a battery pack used as an attachable and detachable electric power source of a notebook personal computer or the like; a medical electronic apparatus such as a pacemaker and a hearing aid; an electric vehicle such as an electric automobile (including a hybrid automobile); and an electric power storage system such as a home battery system for storing electric power for emergency or the like. It goes without saying that an application other than the foregoing applications may be adopted.

In particular, the secondary battery is effectively applicable to the battery pack, the electric vehicle, the electric power storage system, the electric power tool, the electronic apparatus, etc. One reason for this is because, in these applications, since superior battery characteristics are demanded, performance is effectively improved with the use of the secondary battery according to the embodiment of the present technology. It is to be noted that the battery pack is an electric power source using secondary batteries, and is a so-called assembled battery or the like. The electric vehicle is a vehicle that works (runs) with the use of a secondary battery as a driving electric power source. As described above, the electric vehicle may be an automobile (such as a hybrid automobile) including a drive source other than a secondary battery. The electric power storage system is a system using a secondary battery as an electric power storage source. For example, in a home electric power storage system, electric power is stored in the secondary battery as an electric power storage source, and therefore, home electric products and the like become usable with the use of the stored electric power. The electric power tool is a tool in which a movable section (such as a drill) is moved with the use of a secondary battery as a driving electric power source. The electronic apparatus is an apparatus executing various functions with the use of a secondary battery as a driving electric power source (electric power supply source).

Description is specifically given of some application examples of the secondary battery. It is to be noted that the configurations of the respective application examples explained below are mere examples, and may be changed as appropriate.

2-1. Battery Pack

FIG. 4 illustrates a block configuration of a battery pack. For example, the battery pack may include a control section 61, an electric power source 62, a switch section 63, a current measurement section 64, a temperature detection section 65, a voltage detection section 66, a switch control section 67, a memory 68, a temperature detection device 69, a current detection resistance 70, a cathode terminal 71, and an anode terminal 72 in a housing 60. The housing 60 may be made, for example, of a plastic material and/or the like.

The control section 61 controls operation of the whole battery pack (including a used state of the electric power source 62), and may include, for example, a central processing unit (CPU) and/or the like. The electric power source 62 includes one or more secondary batteries (not illustrated). The electric power source 62 may be, for example, an assembled battery including two or more secondary batteries. Connection type of the secondary batteries may be a series-connected type, may be a parallel-connected type, or may be a mixed type thereof. As an example, the electric power source 62 may include six secondary batteries connected in a manner of dual-parallel and three-series. A tab (a connection terminal) that connects the secondary batteries to each other may be made, for example, of one or more of electrically-conductive materials such as iron, copper, and nickel.

The switch section 63 switches the used state of the electric power source 62 (whether or not the electric power source 62 is connectable to an external device) according to an instruction of the control section 61. The switch section 63 may include, for example, a charge control switch, a discharge control switch, a charging diode, a discharging diode, and the like (not illustrated). The charge control switch and the discharge control switch may each be, for example, a semiconductor switch such as a field-effect transistor (MOSFET) using a metal oxide semiconductor.

The current measurement section 64 measures a current with the use of the current detection resistance 70, and outputs the measurement result to the control section 61. The temperature detection section 65 measures temperature with the use of the temperature detection device 69, and outputs the measurement result to the control section 61. The temperature measurement result may be used, for example, for a case in which the control section 61 controls charge and discharge at the time of abnormal heat generation or a case in which the control section 61 performs a correction processing at the time of calculating a remaining capacity. The voltage detection section 66 measures a voltage of the secondary battery in the electric power source 62, performs analog-to-digital conversion on the measured voltage, and supplies the resultant to the control section 61.

The switch control section 67 controls operations of the switch section 63 according to signals inputted from the current measurement section 64 and the voltage detection section 66.

The switch control section 67 executes control so that a charge current is prevented from flowing in a current path of the electric power source 62 by disconnecting the switch section 63 (charge control switch) in the case where, for example, the battery voltage reaches an overcharge detection voltage. Accordingly, in the electric power source 62, only discharge is allowed to be performed through the discharging diode. It is to be noted that, for example, in the case where a large current flows at the time of charge, the switch control section 67 blocks the charge current.

Further, the switch control section 67 executes control so that a discharge current is prevented from flowing in the current path of the electric power source 62 by disconnecting the switch section 63 (discharge control switch) in the case where, for example, the battery voltage reaches an overdischarge detection voltage. Accordingly, in the electric power source 62, only charge is allowed to be performed through the charging diode. It is to be noted that, for example, in the case where a large current flows at the time of discharge, the switch control section 67 blocks the discharge current.

It is to be noted that, in the secondary battery, for example, the overcharge detection voltage may be 4.20 V+/−0.05 V, and the overdischarge detection voltage may be 2.4 V+/−0.1 V.

The memory 68 may be, for example, an EEPROM as a non-volatile memory, or the like. The memory 68 may store, for example, numerical values calculated by the control section 61 and information of the secondary battery measured in a manufacturing step (such as an internal resistance in the initial state). It is to be noted that, in the case where the memory 68 stores a full charge capacity of the secondary battery, the control section 61 is allowed to comprehend information such as a remaining capacity.

The temperature detection device 69 measures temperature of the electric power source 62, and outputs the measurement result to the control section 61. The temperature detection device 69 may be, for example, a thermistor or the like.

The cathode terminal 71 and the anode terminal 72 are terminals connected to an external device (such as a notebook personal computer) driven with the use of the battery pack or an external device (such as a battery charger) used for charging the battery pack. The electric power source 62 is charged and discharged through the cathode terminal 71 and the anode terminal 72.

A specific perspective configuration of the battery pack is shown in FIG. 8, for example. The battery pack may contain, for example, six secondary batteries 113 and a circuit substrate 115 in a space formed by an upper case 111 and a lower case 112.

The upper case 111 and the lower case 112 correspond to the above-described housing 60. Each of the upper case 111 and the lower case 112 may have a wide width portion that contains the secondary batteries 113 and a narrow width portion that contains the circuit substrate 115. Moreover, each of the upper case 111 and the lower case 112 may be provided, for example, with a depression for containing the secondary batteries 113, and a depression for containing the circuit substrate 115. It is to be noted that the shape of each of the upper case 111 and the lower case 112 is not particularly limited.

The six secondary batteries 113 correspond to the above-described electric power source 62. The six secondary batteries 113 may be connected, for example, two in parallel and three in series with the use of a cathode terminal plate 116 and an anode terminal plate 117. It is to be noted that the number and the connection form of the secondary batteries 113 are not particularly limited.

The circuit substrate 115 includes the above-described control section 61, etc. The circuit substrate 115 is provided with an external terminal 114. Therefore, the circuit substrate 115 is connectable to the outside via the external terminal 114.

2-2. Electric Vehicle

FIG. 5 illustrates a block configuration of a hybrid automobile as an example of electric vehicles. For example, the electric vehicle may include a control section 74, an engine 75, an electric power source 76, a driving motor 77, a differential 78, an electric generator 79, a transmission 80, a clutch 81, inverters 82 and 83, and various sensors 84 in a housing 73 made of metal. In addition thereto, the electric vehicle may include, for example, a front drive shaft 85 and a front tire 86 that are connected to the differential 78 and the transmission 80, a rear drive shaft 87, and a rear tire 88.

The electric vehicle may run with the use of, for example, one of the engine 75 and the motor 77 as a drive source. The engine 75 is a main power source, and may be, for example, a petrol engine. In the case where the engine 75 is used as a power source, drive power (torque) of the engine 75 may be transferred to the front tire 86 or the rear tire 88 through the differential 78, the transmission 80, and the clutch 81 as drive sections, for example. The torque of the engine 75 may also be transferred to the electric generator 79. With the use of the torque, the electric generator 79 generates alternating-current electric power. The alternating-current electric power is converted into direct-current electric power through the inverter 83, and the converted power is stored in the electric power source 76. In contrast, in the case where the motor 77 as a conversion section is used as a power source, electric power (direct-current electric power) supplied from the electric power source 76 is converted into alternating-current electric power through the inverter 82. The motor 77 is driven with the use of the alternating-current electric power. Drive power (torque) obtained by converting the electric power by the motor 77 may be transferred to the front tire 86 or the rear tire 88 through the differential 78, the transmission 80, and the clutch 81 as the drive sections, for example.

It is to be noted that, alternatively, the following mechanism may be adopted. In the mechanism, when speed of the electric vehicle is reduced by an unillustrated brake mechanism, the resistance at the time of speed reduction is transferred to the motor 77 as torque, and the motor 77 generates alternating-current electric power by utilizing the torque. It may be preferable that the alternating-current electric power be converted into direct-current electric power through the inverter 82, and the direct-current regenerative electric power be stored in the electric power source 76.

The control section 74 controls operations of the whole electric vehicle, and, for example, may include a CPU and/or the like. The electric power source 76 includes one or more secondary batteries (not illustrated). Alternatively, the electric power source 76 may be connected to an external electric power source, and electric power may be stored by receiving the electric power from the external electric power source. The various sensors 84 may be used, for example, for controlling the number of revolutions of the engine 75 or for controlling opening level (throttle opening level) of an unillustrated throttle valve. The various sensors 84 may include, for example, a speed sensor, an acceleration sensor, an engine frequency sensor, and/or the like.

The description has been given above of the hybrid automobile as an electric vehicle.

However, examples of the electric vehicles may include a vehicle (electric automobile) that operates with the use of only the electric power source 76 and the motor 77 without using the engine 75.

2-3. Electric Power Storage System

FIG. 6 illustrates a block configuration of an electric power storage system. For example, the electric power storage system may include a control section 90, an electric power source 91, a smart meter 92, and a power hub 93 inside a house 89 such as a general residence and a commercial building.

In this case, the electric power source 91 may be connected to, for example, an electric device 94 arranged inside the house 89, and may be connectable to an electric vehicle 96 parked outside the house 89. Further, for example, the electric power source 91 may be connected to a private power generator 95 arranged inside the house 89 through the power hub 93, and may be connectable to an external concentrating electric power system 97 through the smart meter 92 and the power hub 93.

It is to be noted that the electric device 94 may include, for example, one or more home electric appliances such as a refrigerator, an air conditioner, a television, and a water heater. The private power generator 95 may be, for example, one or more of a solar power generator, a wind-power generator, and the like. The electric vehicle 96 may be, for example, one or more of an electric automobile, an electric motorcycle, a hybrid automobile, and the like. The concentrating electric power system 97 may be, for example, one or more of a thermal power plant, an atomic power plant, a hydraulic power plant, a wind-power plant, and the like.

The control section 90 controls operation of the whole electric power storage system (including a used state of the electric power source 91), and, for example, may include a CPU and/or the like. The electric power source 91 includes one or more secondary batteries (not illustrated). The smart meter 92 may be, for example, an electric power meter compatible with a network arranged in the house 89 demanding electric power, and may be communicable with an electric power supplier. Accordingly, for example, while the smart meter 92 communicates with outside, the smart meter 92 controls the balance between supply and demand in the house 89, and thereby, allows effective and stable energy supply.

In the electric power storage system, for example, electric power may be stored in the electric power source 91 from the concentrating electric power system 97 as an external electric power source through the smart meter 92 and the power hub 93, and electric power is stored in the electric power source 91 from the private power generator 95 as an independent electric power source through the power hub 93. The electric power stored in the electric power source 91 is supplied to the electric device 94 and the electric vehicle 96 according to an instruction of the control section 90. Therefore, the electric device 94 becomes operable, and the electric vehicle 96 becomes chargeable. That is, the electric power storage system is a system capable of storing and supplying electric power in the house 89 with the use of the electric power source 91.

The electric power stored in the electric power source 91 is arbitrarily usable.

Therefore, for example, electric power is allowed to be stored in the electric power source 91 from the concentrating electric power system 97 in the middle of the night when an electric rate is inexpensive, and the electric power stored in the electric power source 91 is allowed to be used during daytime hours when an electric rate is expensive.

It is to be noted that the foregoing electric power storage system may be provided for each household (family unit), or may be provided for a plurality of households (family units).

2-4. Electric Power Tool

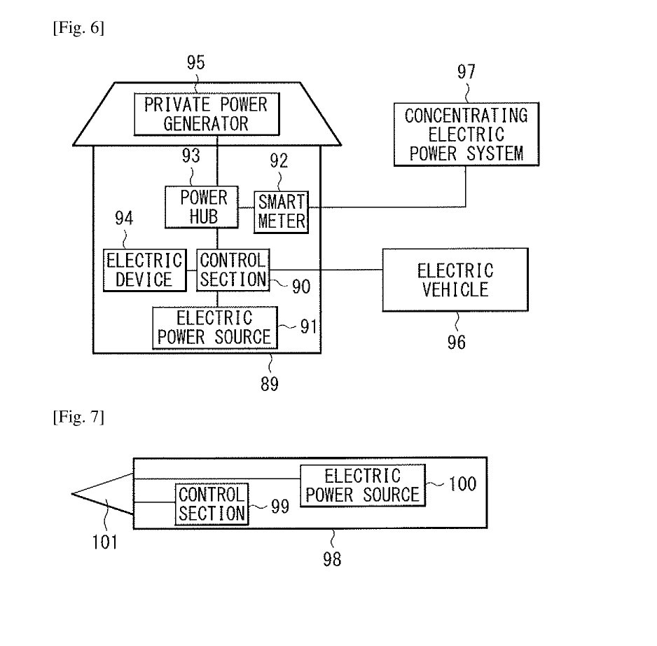

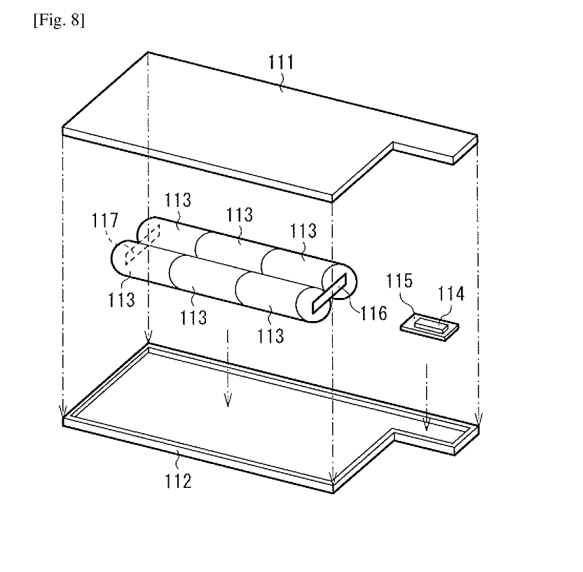

FIG. 7 illustrates a block configuration of an electric power tool. For example, the electric power tool may be an electric drill, and may include a control section 99 and an electric power source 100 in a tool body 98 made of a plastic material and/or the like. For example, a drill section 101 as a movable section may be attached to the tool body 98 in an operable (rotatable) manner.

The control section 99 controls operations of the whole electric power tool (including a used state of the electric power source 100), and may include, for example, a CPU and/or the like. The electric power source 100 includes one or more secondary batteries (not illustrated). The control section 99 allows electric power to be supplied from the electric power source 100 to the drill section 101 according to operation of an unillustrated operation switch.

### EXAMPLES

Specific examples of the embodiment of the present technology are described in detail.

### Examples 1-1 to 1-8

Secondary batteries (lithium ion secondary batteries) of a cylindrical type shown in FIGS. 1 to 3 were fabricated by the following procedures.

When fabricating the cathode 21, first, 91 parts by mass of a cathode active material (LiCoO₂), 6 parts by mass of a cathode binder (polyvinylidene fluoride), and 3 parts by mass of a cathode electric conductor (graphite) were mixed to obtain a cathode mixture. Subsequently, the cathode mixture was dispersed in an organic solvent (N-methyl-2-pyrrolidone) to obtain cathode mixture slurry. Subsequently, both surfaces of the stripe-like cathode current collector 21A (aluminum foil being 15 micrometers thick) were coated with the cathode mixture slurry with the use of a coating device, and the applied cathode mixture slurry was dried to form the cathode active material layer 21B. Lastly, the cathode active material layer 21B was compression-molded with the use of a roll pressing machine.

When fabricating the anode 22, first, 90 parts by mass of an anode active material (artificial graphite) and 10 parts by mass of an anode binder (polyvinylidene fluoride) were mixed to obtain an anode mixture. Subsequently, the anode mixture was dispersed in an organic solvent (N-methyl-2-pyrrolidone) to obtain anode mixture slurry. Subsequently, both surfaces of the stripe-like anode current collector 22A (electrolytic copper foil being 15 micrometers thick) were coated with the anode mixture slurry with the use of a coating device, and the applied anode mixture slurry was dried to form the anode active material layer 22B. Lastly, the anode active material layer 22B was compression-molded with the use of a roll pressing machine.

When preparing the electrolytic solution, electrolyte salt (LiPF₆) was dissolved in a mixture solvent (ethylene carbonate and diethyl carbonate). In this case, the mixture solvent was composed to have a weight ratio of ethylene carbonate:diethyl carbonate=50:50, and the content of the electrolyte salt was set to be 1 mol/kg with respect to the mixture solvent. A specific gravity of this electrolytic solution was 1.30 g/cm³.

When assembling the secondary battery, first, the cathode lead 25 made of aluminum was welded to the cathode current collector 21A, and the anode lead 26 made of nickel was welded to the anode current collector 22A. Subsequently, the cathode 21 and the anode 22 were layered with the separator 23 (microporous polyethylene film being 25 micrometers thick) in between and were spirally wound, and the wounding end portion was fixed with the use of an adhesive tape to fabricate the spirally wound electrode body 20. The melting point (deg C.) and the thickness (micrometer) of the separator 23 were as shown in Table 1. Subsequently, the center pin 24 was inserted in the center of the spirally wound electrode body 20, and then, the spirally wound electrode body 20 was sandwiched by the pair of insulating plates 12 and 13 and was contained inside the battery can 11 made of iron and plated with nickel. The internal volume of the battery can 11 was 16.02 cm³. In this case, the end tip of the cathode lead 25 was welded to the safety valve mechanism 15, and the end tip of the anode lead 26 was welded to the battery can 11.

Subsequently, the electrolytic solution was injected inside the battery can 11 by a depressurization method, and the spirally wound electrode body 20 was impregnated with the electrolytic solution. The volume of the non-impregnation electrolytic solution (the non-impregnation solution amount: cm³) and the non-impregnation solution ratio (%) were as shown in Table 1. The method of measuring each of the non-impregnation solution amount and the non-impregnation solution ratio was as described above. In this case, the non-impregnation solution ratio was adjusted by changing the non-impregnation solution amount in accordance with the injection amount of the electrolytic solution. It is to be noted that the value of the non-impregnation solution ratio was rounded to two decimal places.

Finally, the battery cover 14, the safety valve mechanism 15, and the PTC device 16 were attached to the open end of the battery can 11 by being swaged with the gasket 17. Thus, the secondary battery was completed. It is to be noted that, when fabricating the secondary battery, the thickness of the cathode active material layer 21B was adjusted so that the lithium metal did not precipitate at the anode 22 when the secondary battery was fully charged.

Moreover, the battery pack (assembled battery) shown in FIG. 4 was fabricated with the use of five secondary batteries. When fabricating the electric power source 62, the five secondary batteries were connected in series with the use of an iron tab.

Battery characteristics (load charge-discharge characteristics) and safety (load durability) of the secondary battery were examined and results shown in Table 1 were obtained.

When examining the load charge-discharge characteristics, a battery cell was used. In this case, first, the secondary battery was charged and discharged for one cycle under an ambient temperature environment (23 deg C.) in order to stabilize the battery state. Thereafter, the secondary battery was charged and discharged for another cycle under the same environment, and the discharge capacity was measured. Subsequently, the secondary battery was charged and discharged repeatedly under the same environment until the total number of the cycles reached 100, and the discharge capacity was measured. Based on this results, a load retention rate (%)=(discharge capacity at the 100th cycle/discharge capacity at the 2nd cycle)*100 was calculated. At the time of charge, the secondary battery was charged with a current of 1 C until the voltage (upper-limit voltage) reached 4.2 V, and then, the secondary battery was further charged at a voltage of 4.2 V until the current reached 0.05 C. At the time of discharge, the secondary battery was discharged with a current of 5 C until the voltage (final voltage) reached 2.5 V. It is to be noted that “1 C” is a value of a current that allows the battery capacity (theoretical capacity) to be completely discharged in one hour, and “5 C” is a value of a current that allows the battery capacity to be completely discharged in 0.2 hours.

When examining the load durability, the battery pack (assembled battery) was used. In this case, first, the battery pack was charged under the ambient temperature environment. In this case, the battery pack was charged with a current of 1 C until the voltage reached 21 V (4.2 V per battery cell). Thereafter, the battery pack was further charged at a voltage of 21 V until the current reached 100 mA. Subsequently, the battery pack was connected to an electronic load unit (PLZ-4 W available from Kikusui Electronics Corp.). The battery pack was discharged with a current of 60 A without setting a final voltage, and thereafter, the battery pack was left until the internal temperature thereof became 30 deg C.. Finally, the state (the load state) of the secondary battery during the discharge process was visually evaluated. In this case, the state was evaluated as “fair” when explosion of the battery pack did not occur due to inversion in polarity, and the state was evaluated as “poor” when the explosion of the battery pack occurred.

TABLE 1

| | Electrolytic solution | | Separator | | Anode | | Load | |
|---|---|---|---|---|---|---|---|---|
| | Non-impregnation | Non-impregnation | Melting | | Gas | | retention | |
| | solution amount | solution ratio | point | Thickness | generating | Content | rate | Load |
| Example | (cm³) | (%) | (deg C.) | (μm) | substance | (wt %) | (%) | state |
| 1-1 | 0.04 | 0.25 | 150 | 16 | — | — | 85 | Poor |
| 1-2 | 0.05 | 0.31 | | | | | 86.1 | Fair |
| 1-3 | 0.1 | 0.62 | | 16 | | | 83.3 | Fair |
| 1-4 | 0.25 | 1.56 | | | | | 84.5 | Fair |
| 1-5 | 0.4 | 2.5 | | | | | 82.1 | Fair |
| 1-6 | 1.2 | 7.49 | | | | | 81.1 | Fair |
| 1-7 | 1.3 | 8.11 | | | | | 72 | Fair |

The load retention rate and the load state largely varied in accordance with the non-impregnation solution ratio. In this case, when the non-impregnation solution ratio was within a range from 0.31% to 7.49% both inclusive (Examples 1-2 to 1-6), trouble did not occur in the battery pack while high load retention rate was secured, compared to the case where the non-impregnation solution ratio was out of the above-mentioned range.

### Examples 2-1 to 2-10

As shown in Table 2, secondary batteries were fabricated by similar procedures except for changing the configuration (the melting point and the thickness) of the separator 23, and battery characteristics and safety were examined. In order to change the melting point of the separator 23, the amount of polypropylene added to polyethylene was adjusted.

TABLE 2

| | Electrolytic solution | | Separator | | Anode | | Load | |
|---|---|---|---|---|---|---|---|---|
| | Non-impregnation | Non-impregnation | Melting | | Gas | | retention | |
| | solution amount | solution ratio | point | Thickness | generating | Content | rate | |
| Example | (cm3) | (%) | (deg. C.) | (μm) | substance | (wt %) | (%) | Load state |
| 2-1 | 0.05 | 0.31 | 150 | 5 | — | — | 86.5 | Fair |
| 1-2 | | | 150 | 16 | | | 86.1 | Fair |
| 2-2 | | | 150 | 25 | | | 86.4 | Fair |
| 2-3 | | | 150 | 28 | | | 86.2 | Fair |
| 2-4 | | | 160 | 4 | | | 86.5 | Fair |
| 2-9 | | | 160 | 5 | | | 86.6 | Fair |
| 2-5 | | | 160 | 16 | | | 87.4 | Fair |
| 2-10 | | | 160 | 25 | | | 87.0* | Fair |
| 2-6 | | | 160 | 28 | | | 86.6 | Fair |
| 2-7 | | | 175 | 16 | | | 87.2 | Fair |
| 2-8 | | | 190 | 16 | | | 87.1 | Fair |

Results similar to those shown in Table 1 were obtained also in the case where the configuration of the separator 23 was changed (Table 2). In other words, when the non-impregnation solution ratio was within the above-mentioned range, trouble did not occur in the battery pack while high load retention rate was secured, independently of the configuration of the separator 23.

In particular, when the melting point was 160 deg C. or when the thickness was from 5 micrometers to 25 micrometers both inclusive, the load retention rate was further increased.

### Examples 3-1 to 3-5

Secondary batteries were fabricated by similar procedures except for changing the configuration (presence or absence of the gas generating substance) of the anode 22, and battery characteristics and safety were examined.

When preparing the anode mixture, the anode active material and the anode binder were mixed, and then, lithium carbonate (LiCO₃) as the gas generating substance was added to the mixture. The content (wt %) of the gas generating substance in the anode active material layer 22B was as shown in Table 3.

TABLE 3

| | Electrolytic solution | | Separator | | Anode | | Load | |
|---|---|---|---|---|---|---|---|---|
| | Non-impregnation | Non-impregnation | Melting | | Gas | | retention | |
| | solution amount | solution ratio | point | Thickness | generating | Content | rate | Load |
| Example | (cm³) | (%) | (deg C.) | (μm) | substance | (wt %) | (%) | state |
| 1-2 | 0.05 | 0.31 | 150 | 16 | Li₂CO₃ | 0 | 86.1 | Fair |
| 3-1 | | | | | | 0.02 | 86.6 | Fair |
| 3-2 | | | | | | 0.8 | 86.5 | Fair |
| 3-3 | | | | | | 1.6 | 86.4 | Fair |
| 3-4 | | | | | | 3 | 86.5 | Fair |
| 3-5 | | | | | | 3.1 | 86.2 | Fair |

Results similar to those shown in Table 1 were obtained also in the case where the configuration of the anode 22 was changed (Table 3). In other words, when the non-impregnation solution ratio was within the above-mentioned range, trouble did not occur in the battery pack while high load retention rate was secured, independently of the configuration of the anode 22.

In particular, when the anode active material layer 22B contained the gas generating substance (Examples 3-1 to 3-5), the load retention rate was further increased compared to the case where the anode active material layer 22B did not contain the gas generating substance (Example 1-2). In this case, the load retention rate was further increased when the content of the gas generating substance was from 0.02 wt % to 3 wt % both inclusive.

As can be seen from the results shown in Tables 1 to 3, in the secondary battery provided with the safety valve mechanism 15, load durability was improved while superior load charge-discharge characteristics were maintained when the non-impregnation solution ratio (at a battery voltage of 4.2 V) was from 0.31% to 7.49% both inclusive. Therefore, both improvement in battery characteristics and improvement in securing safety were achieved.

The present technology has been described above referring to the preferred embodiment and Examples. However, the present technology is not limited to the examples described in the preferred embodiment and Examples, and may be variously modified. For example, the description has been given with the specific examples of the case in which the secondary battery is of the cylindrical type, and the electrode structure has the spirally wound structure. However, applicable structures are not limited thereto. The secondary battery of the present technology may have other forms such as a square type, a coin type, and a button type. The electrode structure may have other structure such as a laminated structure.

Moreover, in the above embodiment and Examples, description has been given of the lithium ion secondary battery in which the capacity of the anode is obtained by insertion and extraction of lithium. However, this is not limitative. For example, the secondary battery according to the embodiment of the present technology may be a lithium metal secondary battery in which the capacity of the anode is obtained by precipitation and dissolution of lithium. Alternatively, the secondary battery according to the embodiment of the present technology may be a secondary battery in which the capacity of the anode is obtained as the sum of the capacity obtained by insertion and extraction of lithium and the capacity obtained by precipitation and dissolution of lithium by allowing the capacity of the anode material capable of inserting and extracting lithium to be smaller than the capacity of the cathode.

Moreover, the description has been given of the case in which lithium is used as the electrode reactant in the above embodiment and Examples. However, the electrode reactant is not limited thereto. The electrode reactant may be, for example, other Group 1 element in the long form of the periodic table such as sodium (Na) and potassium (K), a Group 2 element in the long form of the periodic table such as magnesium and calcium, or other light metal such as aluminum. Alternatively, the electrode reactant may be an alloy including one or more of the above-described series of elements.

The effects described in the present specification are mere examples. The effects of the present technology are not limited thereto, and may include other effects.

It is possible to achieve at least the following configurations from the above-described example embodiments and the modifications of the disclosure.

(1)

A secondary battery including:

an outer package;

an electrode structure contained inside the outer package;

an electrolytic solution contained inside the outer package, and including an impregnation electrolytic solution with which the electrode structure is impregnated and a non-impregnation electrolytic solution with which the electrode structure is not impregnated; and

a safety mechanism configured to interrupt a current in accordance with an internal pressure of the outer package, wherein

a ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

(2)

The secondary battery according to (1), wherein

the electrode structure includes a cathode and an anode that face each other with a separator in between,

the separator has a melting point of 160 degrees Celsius or higher, and

the separator has a thickness from 5 micrometers to 25 micrometers both inclusive.

(3)

The secondary battery according to (1) or (2), wherein

the electrode structure includes a cathode and an anode that face each other with a separator in between, and

the anode includes a material that electrochemically generates gas at an anode potential of 3 volts or higher with respect to lithium metal.

(4)

The secondary battery according to (3), wherein the material includes carbonate, phosphate, or both.

(5)

The secondary battery according to (3) or (4), wherein

the anode includes an anode active material layer provided on an anode current collector,

the anode active material layer includes the material, and

a content of the material in the anode active material layer is from 0.02 weight percent to 3 weight percent both inclusive.

(6)

The secondary battery according to any one of (1) to (5), wherein the secondary battery is a lithium secondary battery.

(7)

A secondary battery including:

an outer package;

an electrode structure contained inside the outer package;

an electrolytic solution contained inside the outer package, and including an impregnation electrolytic solution with which the electrode structure is impregnated and a non-impregnation electrolytic solution with which the electrode structure is not impregnated; and

a safety mechanism configured to interrupt a current in accordance with an internal pressure of the outer package, wherein

a volume of the non-impregnation electrolytic solution is a volume that allows an internal pressure of the outer package to increase up to a pressure that allows the safety mechanism to operate in an over-load state.

(8)

A battery pack including:

the secondary battery according to any one of (1) to (6);

a control section configured to control operation of the secondary battery; and

a switch section configured to switch the operation of the secondary battery according to an instruction of the control section.

(9)

An electric vehicle including:

the secondary battery according to any one of (1) to (6);

a conversion section configured to convert electric power supplied from the secondary battery into drive power;

a drive section configured to operate according to the drive power; and

a control section configured to control operation of the secondary battery.

(10)

An electric power storage system including:

the secondary battery according to any one of (1) to (6);

one or more electric devices configured to be supplied with electric power from the secondary battery; and

a control section configured to control the supplying of the electric power from the secondary battery to the one or more electric devices.

(11)

An electric power tool including:

the secondary battery according to any one of (1) to (6); and

a movable section configured to be supplied with electric power from the secondary battery.

(12)

An electronic apparatus including

the secondary battery according to any one of (1) to (6) as an electric power supply source.

(13)

A secondary battery comprising:

an outer package;

an electrode structure contained inside the outer package, wherein the electrode structure includes an anode and a cathode;

an electrolytic solution contained inside the outer package, and including an impregnation electrolytic solution with which the electrode structure is impregnated and a non-impregnation electrolytic solution with which the electrode structure is not impregnated; and

a safety valve mechanism configured to interrupt a current in accordance with an internal pressure of the outer package, wherein the non-impregnation electrolytic solution is in an amount so as to increase an operation probability of the safety valve mechanism.

(14)

The secondary battery according to (13), wherein the amount of the non-impregnation electrolytic solution is associated with a ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

(15)

The secondary battery according to (14), wherein the ratio of a volume of the non-impregnation electrolytic solution to an internal volume of the outer package is from 0.31 percent to 1.56 percent both inclusive when a battery voltage is 4.2 volts.

(16)

The secondary battery according to (13), wherein the anode includes a material that electrochemically generates gas at an anode potential so as to increase the operation probability of the safety valve mechanism.

(17)

The secondary battery according to (16), wherein

the anode includes an anode active material layer provided on an anode current collector,

the anode active material layer includes the material, and

a content of the material in the anode active material layer is from 0.02 weight percent to 3 weight percent both inclusive.

(18)

The secondary battery according to (16), wherein the material includes at least one of a carbonate and a phosphate.

(19)

The secondary battery according to (18), wherein the material includes a lithium carbonate.

(20)

The secondary battery according to (13), wherein

the cathode and the anode face each other with a separator in between,

the separator has a melting point of 160 degrees Celsius or higher, and

the separator has a thickness from 5 micrometers to 25 micrometers both inclusive.

(21)

The secondary battery according to (13), wherein

the cathode and the anode face each other with a separator in between, and

the anode includes a material that electrochemically generates gas at an anode potential of 3 volts or higher with respect to lithium metal.

(22)

The secondary battery according to (21), wherein

the anode includes an anode active material layer provided on an anode current collector,

the anode active material layer includes the material, and

a content of the material in the anode active material layer is from 0.02 weight percent to 3 weight percent both inclusive.

(23)

The secondary battery according to (13), wherein the secondary battery is a lithium secondary battery.

(24)

A secondary battery comprising:

an outer package;

an electrode structure contained inside the outer package, wherein the electrode structure includes an anode and a cathode;

an electrolytic solution contained inside the outer package, and

a safety valve mechanism configured to interrupt a current in accordance with an internal pressure of the outer package, wherein the anode includes a material that electrochemically generates gas at an anode potential so as to increase an operation probability of the safety valve mechanism.

(25)

The secondary battery according to (24), wherein the material includes at least one of a carbonate and a phosphate.

(26)

The secondary battery according to (25), wherein the material includes a lithium carbonate.

(27)

The secondary battery according to (24), wherein

the cathode and the anode face each other with a separator in between,

the separator has a melting point of 160 degrees Celsius or higher, and

the separator has a thickness from 5 micrometers to 25 micrometers both inclusive.

(28)

The secondary battery according to (24), wherein

the cathode and the anode face each other with a separator in between, and

the anode includes the material that electrochemically generates gas at an anode potential of 3 volts or higher with respect to lithium metal.

(29)

The secondary battery according to (28), wherein the electrolytic solution includes a non-impregnation electrolytic solution with which the electrode structure is not impregnated, and wherein the non-impregnation solution is in an amount so as to increase the operation probability of the safety valve mechanism.

(30)

The secondary battery according to (28), wherein

the anode includes an anode active material layer provided on an anode current collector,

the anode active material layer includes the material, and

a content of the material in the anode active material layer is from 0.02 weight percent to 3 weight percent both inclusive.

(31)

A battery pack comprising:

a secondary battery;

a control section configured to control operation of the secondary battery; and

a switch section configured to switch the operation of the secondary battery according to an instruction of the control section, wherein

the secondary battery includes

an outer package,

an electrode structure contained inside the outer package, wherein the electrode structure includes an anode and a cathode,

an electrolytic solution contained inside the outer package, and including an impregnation electrolytic solution with which the electrode structure is impregnated and a non-impregnation electrolytic solution with which the electrode structure is not impregnated, and

a safety valve mechanism configured to interrupt a current in accordance with an internal pressure of the outer package, wherein the non-impregnation electrolytic solution is in an amount so as to increase an operation probability of the safety valve mechanism.

(32)

The battery pack according to (31), wherein

a ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

(33)

A battery pack comprising:

a secondary battery;

a control section configured to control operation of the secondary battery; and

a switch section configured to switch the operation of the secondary battery according to an instruction of the control section, wherein

the secondary battery includes

an outer package,

an electrode structure contained inside the outer package, wherein the electrode structure includes an anode and a cathode;

an electrolytic solution contained inside the outer package, and

a safety valve mechanism configured to interrupt a current in accordance with an internal pressure of the outer package, wherein the anode includes a material that electrochemically generates gas at an anode potential so as to increase an operation probability of the safety valve mechanism.

(34)

The battery pack according to (33), wherein the material includes at least one of a carbonate and a phosphate.

(35)

The battery pack according to (34), wherein the material includes a lithium carbonate.

It should be understood by those skilled in the art that various modifications, combinations, sub-combinations, and alterations may occur depending on design requirements and other factors insofar as they are within the scope of the appended claims or the equivalents thereof.

### REFERENCE SIGNS LIST

11 Battery can
15 Safety valve mechanism
20 Spirally wound electrode body
21 Cathode
21A Cathode current collector
21B Cathode active material layer
22 Anode
22A Anode current collector
22B Anode active material layer
23 Separator

1. A secondary battery comprising:
an outer package;
an electrode structure contained inside the outer package, wherein the electrode structure includes an anode and a cathode;
an electrolytic solution contained inside the outer package, and including an impregnation electrolytic solution with which the electrode structure is impregnated and a non-impregnation electrolytic solution with which the electrode structure is not impregnated; and
a safety valve mechanism configured to interrupt a current in accordance with an internal pressure of the outer package, wherein the non-impregnation electrolytic solution is in an amount so as to increase an operation probability of the safety valve mechanism.

2. The secondary battery according to claim 1, wherein the amount of the non-impregnation electrolytic solution is associated with a ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

3. The secondary battery according to claim 2, wherein the ratio of a volume of the non-impregnation electrolytic solution to an internal volume of the outer package is from 0.31 percent to 1.56 percent both inclusive when a battery voltage is 4.2 volts.

4. The secondary battery according to claim 1, wherein the anode includes a material that electrochemically generates gas at an anode potential so as to increase the operation probability of the safety valve mechanism.

5. The secondary battery according to claim 4, wherein
the anode includes an anode active material layer provided on an anode current collector,
the anode active material layer includes the material, and
a content of the material in the anode active material layer is from 0.02 weight percent to 3 weight percent both inclusive.

6. The secondary battery according to claim 4, wherein the material includes at least one of a carbonate and a phosphate.

7. The secondary battery according to claim 6, wherein the material includes a lithium carbonate.

8. The secondary battery according to claim 1, wherein
the cathode and the anode face each other with a separator in between,
the separator has a melting point of 160 degrees Celsius or higher, and
the separator has a thickness from 5 micrometers to 25 micrometers both inclusive.

9. The secondary battery according to claim 1, wherein
the cathode and the anode face each other with a separator in between, and
the anode includes a material that electrochemically generates gas at an anode potential of 3 volts or higher with respect to lithium metal.

10. The secondary battery according to claim 9, wherein
the anode includes an anode active material layer provided on an anode current collector,
the anode active material layer includes the material, and
a content of the material in the anode active material layer is from 0.02 weight percent to 3 weight percent both inclusive.

11. The secondary battery according to claim 1, wherein the secondary battery is a lithium secondary battery.

12. A secondary battery comprising:
an outer package;
an electrode structure contained inside the outer package, wherein the electrode structure includes an anode and a cathode;
an electrolytic solution contained inside the outer package, and
a safety valve mechanism configured to interrupt a current in accordance with an internal pressure of the outer package, wherein the anode includes a material that electrochemically generates gas at an anode potential so as to increase an operation probability of the safety valve mechanism.

13. The secondary battery according to claim 12, wherein the material includes at least one of a carbonate and a phosphate.

14. The secondary battery according to claim 13, wherein the material includes a lithium carbonate.

15. The secondary battery according to claim 12, wherein
the cathode and the anode face each other with a separator in between,
the separator has a melting point of 160 degrees Celsius or higher, and
the separator has a thickness from 5 micrometers to 25 micrometers both inclusive.

16. The secondary battery according to claim 12, wherein
the cathode and the anode face each other with a separator in between, and
the anode includes the material that electrochemically generates gas at an anode potential of 3 volts or higher with respect to lithium metal.

17. The secondary battery according to claim 16, wherein the electrolytic solution includes a non-impregnation electrolytic solution with which the electrode structure is not impregnated, and wherein the non-impregnation solution is in an amount so as to increase the operation probability of the safety valve mechanism.

18. The secondary battery according to claim 16, wherein
the anode includes an anode active material layer provided on an anode current collector,
the anode active material layer includes the material, and a content of the material in the anode active material layer is from 0.02 weight percent to 3 weight percent both inclusive.

19. A battery pack comprising:
a secondary battery;
a control section configured to control operation of the secondary battery; and
a switch section configured to switch the operation of the secondary battery according to an instruction of the control section, wherein
the secondary battery includes
an outer package,
an electrode structure contained inside the outer package, wherein the electrode structure includes an anode and a cathode,
an electrolytic solution contained inside the outer package, and
including an impregnation electrolytic solution with which the electrode structure is impregnated and a non-impregnation electrolytic solution with which the electrode structure is not impregnated, and
a safety valve mechanism configured to interrupt a current in accordance with an internal pressure of the outer package, wherein the non-impregnation electrolytic solution is in an amount so as to increase an operation probability of the safety valve mechanism.

20. The battery pack according to claim 19, wherein
a ratio of a volume of the non-impregnation electrolytic solution to an internal volume of the outer package ([the volume of the non-impregnation electrolytic solution/the internal volume of the outer package]*100) is from 0.31 percent to 7.49 percent both inclusive when a battery voltage is 4.2 volts.

21. A battery pack comprising:
a secondary battery;
a control section configured to control operation of the secondary battery; and
a switch section configured to switch the operation of the secondary battery according to an instruction of the control section, wherein
the secondary battery includes
an outer package,
an electrode structure contained inside the outer package, wherein the electrode structure includes an anode and a cathode;
an electrolytic solution contained inside the outer package, and
a safety valve mechanism configured to interrupt a current in accordance with an internal pressure of the outer package, wherein the anode includes a material that electrochemically generates gas at an anode potential so as to increase an operation probability of the safety valve mechanism.

22. The battery pack according to claim 21, wherein the material includes at least one of a carbonate and a phosphate.

23. The battery pack according to claim 22, wherein the material includes a lithium carbonate.
